(19) United States
(12) Patent Application Publication
(10) Pub. No.: US 2021/0304153 A1
(43) Pub. Date: Sep. 30, 2021

(54) UTILIZING A TRANSPORTATION MATCHING SYSTEM IN CONJUNCTION WITH A MULTI-TRACK VEHICLE SERVICE CENTER TO SERVICE TRANSPORTATION VEHICLES

(71) Applicant: Lyft, Inc., San Francisco, CA (US)

(72) Inventors: Stephen Joseph Calvillo, San Francisco, CA (US); James Nicholas De Angelis, San Francisco, CA (US); Katherine Anne Johnson, San Francisco, CA (US); Aditya Ganesh Kamath, Mountain View, CA (US); Matthew James Vere Nicoll, Pleasanton, CA (US); Christy Maria Ortins, San Leandro, CA (US); Londa Fiorella Overbeck, San Francisco, CA (US); Taylor Lee Putnam, Oakland, CA (US); Limin Shen, San Francisco, CA (US); Laerte Meneghette Zatta, Tracy, CA (US)

(21) Appl. No.: 16/834,567

(22) Filed: Mar. 30, 2020

(51) Int. Cl. G06Q 10/00; G06Q 10/10; G06K 9/00

(52) U.S. Cl. CPC G06Q 10/20; G06K 9/00671; G06Q 10/1095

(57) ABSTRACT

This disclosure covers computer-implemented methods, non-transitory computer readable media, and systems that improve efficiency, accuracy, and flexibility in servicing provider vehicles associated with a transportation matching system. For example, the disclosed systems can match transportation provider vehicles to vehicle services at one or more multi-track vehicle service centers, guide provider vehicles through various tracks and services, and generate user interfaces for accurately and efficiently notifying provider devices and technician devices as vehicles progress through the multi-track vehicle service centers.

### BACKGROUND

Recent years have seen a significant shift in transportation systems, as the inefficiency and cost of traditional transportation approaches fails to keep pace with advances in computing technology. For example, under conventional transportation models, individuals undergo the time and expense of obtaining, operating, servicing, insuring, maintaining, parking and managing a vehicle. In recent years, however, the popularity and usage of on-demand transportation matching systems have increased significantly. Indeed, the proliferation of web and mobile applications allow requestor devices to obtain transportation through on-demand transportation matching system via provider devices, including autonomous vehicles. These on-demand transportation matching systems facilitate real-time, dynamic matching across provider computer devices and requestor computer devices, resulting in the completion of thousands of transportation requests each day, and allowing individuals to forego many of the expenses and inefficiencies associated with traditional transportation approaches. That said, transportation services provided via on-demand transportation systems are still dependent on provider vehicles. These vehicles, in turn, require regular servicing so that the vehicles can operate in a safe and efficient manner.

Accordingly, despite recent advances, many on-demand transportation matching systems still suffer from a number of significant deficiencies. Indeed, as just mentioned, many on-demand transportation matching systems still rely on individual provider devices that require maintenance via conventional vehicle service centers. These conventional vehicle service centers suffer from a number of inefficiencies and other disadvantages, particularly in relation to speed and efficiency. For example, conventional vehicle service centers typically utilize layouts that include a number of stations for a variety of services arrayed in a manner (e.g., in a “hairstyle salon” layout against a wall) that allows service technicians to place vehicles in any of the stations. While this allows service technicians to operate on any of the vehicles in any order and for any amount of time based on the type of service, such a layout leads to inefficiencies. Specifically, this conventional layout typically requires technicians to back vehicles out of a station before moving the vehicles to other stations for providing different services. Additionally, this conventional layout can result in vehicles staying in stations for long periods of time (e.g., before a technician begins a service or even after a technician completes the service), or even taking a vehicle out of a station to complete the service at a later time.

Moreover, conventional vehicle service centers typically utilize inflexible, inefficient, and inaccurate computing systems. For example, conventional vehicle service centers often utilize computing systems that rigidly track scheduled appointments and services requested. These computing systems do not provide any additional functionality or flexibility in managing real-time realities of maintenance, such as delays in customers providing vehicles, unexpected changes to services, technician availability, etc.

In addition, conventional service center computing systems are inefficient. Indeed, such systems often require significant user interactions by technicians to identify pertinent data (e.g., to look up individual vehicles, determine services performed, etc.). Accordingly, such systems require significant user interaction, time, and processing power to implement. Furthermore, such systems introduce additional inefficiencies in that they are inaccessible to vehicle operators. Accordingly, such systems require numerous interactions by technicians each time a vehicle owner seeks information regarding a vehicle.

Furthermore, conventional service center computing systems are also inaccurate. For example, when the need for unexpected services arise, conventional service center computing systems often fail to reflect the actual services performed (and/or cause services to be performed that are unneeded). Indeed, conventional computing systems often omit or include erroneous additional services than those actually performed or needed. In addition, conventional service center computing systems often generate inaccuracies in scheduling. For example, when coordinating services of many different vehicles throughout a day or week, conventional vehicle service centers computing systems usually approach setting appointments by filling time slots. This often leads to inaccurate time estimates when circumstances change, such as when vehicle services take longer than planned. Unexpected delays can thus produce inaccurate estimates of service schedules, which results in wasting time, as well as unnecessarily occupying space with vehicles that are waiting for delayed services. Accordingly, conventional service center computing systems often generate inaccurate time estimates and/or create scheduling conflicts (e.g., fail to accommodate changes as vehicles are unexpectedly added or removed).

### SUMMARY

This disclosure describes one or more embodiments of systems, methods, service centers, and non-transitory computer readable media that solve the foregoing problems in addition to providing other benefits. As will be described in more detail below, the disclosed systems provide improved efficiency, accuracy, and flexibility in servicing provider vehicles associated with a transportation matching system. For example, the disclosed systems can utilize a transportation matching system to dynamically match a provider device to a multi-track vehicle service center based on transportation requests and geo-location data of the provider device, projected time availability within the service center, and/or projected maintenance needs of the provider vehicle. Furthermore, the disclosed systems can improve accuracy and efficiency by dispatching a provider vehicle to one or more tracks of a multi-track vehicle service center, including a maintenance track, a service track, and a collision track (each with a single entry point and a single exit point for vehicles to provide a more efficient physically structured order of servicing provider vehicles). The disclosed systems can dynamically monitor provider vehicles as they progress through these tracks while providing streamlined user interfaces to provider devices and technician devices that include notifications regarding status updates, services issues, requests for additional services, and dispatches to different tracks.

For example, after a provider vehicle has entered a maintenance track of a vehicle service center, the disclosed systems can obtain vehicle data for the provider vehicle while in the maintenance track (e.g., using cameras) and use the vehicle data to determine whether to dispatch the provider vehicle to another track (i.e., the service track or the collision track). Additionally, in response to determining to dispatch the provider vehicle to another track, the disclosed systems can notify a provider device associated with the provider vehicle and request permission to dispatch the provider vehicle to the other track. The disclosed systems can thus efficiently service provider vehicles by moving the provider vehicles through the structured tracks while maintaining communication with provider devices.

Additional features and advantages of one or more embodiments of the present disclosure will be set forth in the description which follows, and in part will be obvious from the description, or may be learned by the practice of such example embodiments.

### BRIEF DESCRIPTION OF THE DRAWINGS

The detailed description refers to the drawings briefly described below.

FIG. 1 illustrates a block diagram of an environment for implementing a vehicle service matching system in accordance with one or more embodiments.

FIG. 2 illustrates a block diagram of matching and servicing a provider vehicle in accordance with one or more embodiments.

FIGS. 3A-3C illustrates vehicle service centers including a maintenance track, a service track, and a collision track in accordance with one or more embodiments.

FIGS. 4A-4J illustrate graphical user interfaces of a provider device and a technician device for scheduling and performing a service for a provider vehicle in accordance with one or more embodiments.

FIG. 4K illustrates a diagram for determining a vehicle health score for a provider vehicle in accordance with one or more embodiments.

FIG. 5 illustrates a block diagram of the vehicle service matching system of FIG. 1 in accordance with one or more embodiments.

FIG. 6 illustrates a flowchart of a series of acts in a method of scheduling and performing a service for a provider vehicle in accordance with one or more embodiments.

FIG. 7 illustrates a block diagram of a computing device in accordance with one or more embodiments.

FIG. 8 illustrates an example environment for a transportation matching system in accordance with one or more embodiments.

### DETAILED DESCRIPTION

One or more embodiments of the present disclosure include a vehicle service matching system (or simply “service matching system”) that matches transportation provider vehicles to vehicle services at one or more multi-track vehicle service centers, guides provider vehicles through various tracks and services, and generates user interfaces for accurately and efficiently notifying provider devices and technician devices as vehicles progress through the multi-track vehicle service centers. For example, the service matching system can leverage information regarding provider vehicles and transportation requests from a transportation matching system to efficiently and accurately schedule services for transportation provider vehicles at various multi-track vehicle service centers. The service matching system can register provider vehicles as they arrive and guide the provider vehicles through one or more tracks of a multi-track vehicle service center, including a maintenance track, service track, or collision track. Furthermore, the service matching system can generate a variety of user interfaces for provider devices and technician devices to provide information regarding updates, services performed, maintenance issues, and dispatch through different tracks of the multi-track vehicle service centers. In this manner, the vehicle service center matching system can efficiently, accurately, and flexibly support fleets of millions of vehicles, including autonomous vehicles, in providing efficient transportation services that resolve many of the shortcomings of conventional transportation models.

For example, in one or more embodiments, the service matching system can utilize a transportation matching system to schedule a service time for a provider vehicle and notify a provider device based on the availability of the provider vehicle and a vehicle service center. The service center can include a maintenance track, a service track, and a collision track (or other tracks) for performing various types of services on provider vehicles, with each track including a single entry point and a single exit point. Once the provider vehicle has entered the maintenance track, the service matching system can determine whether to dispatch the provider vehicle to another track based on identified issues in the maintenance track and request permission to dispatch the vehicle from the provider device. By managing provider vehicle service times based on provider vehicle availability and vehicle service center availability, the service matching system can avoid unnecessary use of space and wasted time by scheduling and routing provider vehicles based on current availability. Additionally, utilizing a multi-track vehicle service centers with a single entry and exit point for each track provides an efficient, structured flow to service operations on provider vehicles.

As mentioned, the service matching system can utilize a transportation matching system to schedule a time slot for servicing a provider vehicle. Specifically, in one or more embodiments, the service matching system can maintain servicing information (e.g., a maintenance log or database) that indicates the historical and projected maintenance needs of provider vehicles corresponding to the transportation matching system. In response to identifying a projected maintenance need, the service matching system can determine a location and/or transportation route associated with the provider vehicle. Additionally, the service matching system can determine an availability of a station in a maintenance track of a vehicle service center located near the provider vehicle. Based on the maintenance need, the availability of the provider vehicle, and the station in the maintenance track, the service matching system can schedule a time for the provider vehicle and notify a provider device associated with the provider vehicle of the scheduled time.

When a provider vehicle arrives at a vehicle service center for a scheduled service, the service matching system can register the provider vehicle and dispatch the provider vehicle to a particular track. For example, the service matching system can register a vehicle based on GPS location data indicating that the vehicle has arrived at the multi-track vehicle service center. Moreover, in some embodiments, the service matching system can register a vehicle based on capturing one or more digital images of the vehicle. For instance, the service matching system can capture a digital image of the vehicle, identify and register the vehicle based on the digital image, and identify unknown maintenance issues based on the digital image.

Moreover, the service matching system can dispatch the vehicle to a track (e.g., based on identified maintenance needs). As mentioned above, the multi-track vehicle service center can include three or more tracks (e.g., a maintenance track, a service track, and a collision track), each of which is a linear track with a single entry point and a single exit point (e.g., only a single entry point and only a single exit point). The service matching system can direct the provider vehicle to enter the single entry point of the maintenance track (or another track) and then perform one or more maintenance services on the provider vehicle along the maintenance track. For example, the service matching system can move the provider along a number of stations in a linear arrangement to perform various operations in a maintenance service.

In one or more embodiments, the service matching system can then determine whether to dispatch a provider vehicle to another track at the vehicle service center based on vehicle data obtained from the provider vehicle in the maintenance track. For instance, the service matching system can capture, or otherwise obtain, one or more images of the provider vehicle within the maintenance track using one or more cameras positioned along the maintenance track. The service matching system can then use the obtained data to determine whether to dispatch the provider vehicle to another track based on whether the service matching system identifies any issues (e.g., collision damage, leaks, or broken/worn vehicle parts).

In response to determining to dispatch a provider vehicle from a maintenance track to one or more other tracks, the service matching system can notify a provider device of the additional services and request permission to perform the additional services in one or more other tracks. When dispatching the provider vehicle to another track after receiving permission, the service matching system can dispatch the provider vehicle out the single exit point of the maintenance track to the single entry point of the service track or the single entry point of the collision track. The service matching system can then perform the additional service(s) in the other track.

As previously mentioned, the service matching system described herein provides a variety of advantages over conventional vehicle service systems. In particular, the service matching system improves the efficiency of a vehicle service center that services vehicles by utilizing separate tracks, each of which is a linear track having a single entry point and a single exit point, to provide a structured order of services. In contrast to conventional vehicle service systems that can delay services initiated on vehicles due to the physical layout of the service locations, the service matching system utilizes a physical layout that ensures that maintenance and other services that begin on a provider vehicle are completed in a timely manner.

Moreover, the service matching system can improve flexibility relative to conventional service center computing systems. As mentioned above, the service matching system can dynamically schedule services based on real-time provider location data, up-to-date availability of service center tracks, and transportation requests that the provider device can fulfill in travelling to (or from) a multi-track vehicle service center. Furthermore, the service matching system can monitor vehicles as they move through service center tracks, dynamically identify maintenance needs, update provider and technician devices, and dispatch vehicles through different tracks. Accordingly the service matching significantly improves functionality and flexibility of implementing computing systems.

In addition, the service matching system also improves efficiency relative to conventional service center computing systems. Indeed, as mentioned, the service matching system can generate efficient user interfaces for provider devices and technician devices that provide status updates, requests for additional services, dispatch notifications within a multi-track service center, service issue notifications, and arrival notifications. The service matching system can thus significantly reduce the user interactions, time, and resources needed to search for, identify, and/or share information with regard to servicing transportation vehicles.

Further, the service matching system can improve accuracy over conventional service center computing systems. By monitoring services as they are performed in linear tracks and providing user interfaces for transmitting services as they are performed to provider devices and/or technician devices, the service matching system can accurately identify services performed on various vehicles. The service matching system can also reduce erroneous and unnecessary services from being performed.

Moreover, by leveraging a transportation matching system (e.g., location data and transportation requests serviced by vehicles) together with linear tracks within a service center, the service matching system can significantly improve the accuracy of time estimates and reduce scheduling conflicts. Specifically, by leveraging information about transportation routes involving a provider vehicle and availability of one or more vehicle service centers, the service matching system can schedule a service time that reduces or eliminates a wait time before performing the service on the provider vehicle. For instance, in contrast to conventional systems that schedule service appointments ahead of time during (often inaccurate) time ranges, the service matching system can utilize the transportation matching system to notify provider devices of an upcoming availability of a service time slot while also matching the provider device to transportation requests near the vehicle service center based on the service time slot.

In short, the service matching system can significantly improve conventional systems, reducing the costs and inefficiencies of conventional transportation models. Indeed, the service matching system can reduce inefficiencies and costs of individual vehicle operation, and instead, utilize the transportation matching system to service large vehicle fleets with reduced time and expense.

As illustrated by the foregoing discussion, the present disclosure utilizes a variety of terms to describe features and advantages of the vehicle service matching system. Additional detail is now provided regarding the meaning of such terms. For example, as used herein, the term “vehicle service center” refers to a location at which one or more service technicians perform services on vehicles. For example, a vehicle service center can include one or more service stations where service technicians perform services on vehicles. A vehicle service center can also include a number of different tracks for performing different services on vehicles (e.g., a maintenance track, a service track, and/or a collision track). A vehicle service center can also include one or more computing devices for managing services and/or communicating with other computing devices.

As used herein, the term “maintenance track” refers to a lane or channel with one or more stations for performing a first set of services on vehicles. For example, the first set of services may include services corresponding to regular maintenance services by a manufacturer of a vehicle. As used herein, the term “service track” refers to a linear lane or channel with one or more stations for performing a second set of services on vehicles. More specifically, the second set of services may include services not performed in the maintenance track. For example, the “maintenance track” can perform routine maintenance services (such as an oil change) whereas the “service track” can perform more time-consuming, non-routine services (e.g., replacing a head gasket). Additionally, as used herein, the term “collision track” refers to a linear lane or channel with one or more stations for performing a third set of services on vehicles. For instance, the third set of services can include serves related to body repair, collision repair, and/or vehicle paint services. Accordingly, as used herein, the term “maintenance issue” refers to vehicle issues (e.g., service needs) related to services performed within the “maintenance track,” the term “service issue” refers to vehicle issues (e.g., service needs) related to services performed within the “service track,” and the term “collision issue” refers to vehicle issues (e.g., service needs) related to services performed within the “collision track.”

As used herein, the term “entry point” refers to a location, place, opening, or area at which a vehicle enters a track. Accordingly, a single entry point indicates a single place at which vehicles can enter a track. Also, as used herein, the term “exit point” refers to a location, place, opening, or area at which a vehicle leaves a track. Thus, a single exit point indicates a single place at which vehicles can leave the track.

As used herein, the term “dispatch” refers to one or more acts involved in directing or transferring a provider vehicle to a track in a vehicle service center. Accordingly, dispatching a provider vehicle from a maintenance track to a service track or a collision track can include directing the provider vehicle from the single exit point of the maintenance track to the single entry point of the service track or the collision track. Additionally, dispatching a provider vehicle can include providing instructions or a request to a provider device indicating the dispatch of the provider vehicle to another track. In one or more embodiments, dispatching a provider vehicle to another track can also include updating a status (e.g., track, service) of the provider vehicle.

As used herein, the term “transportation matching system” refers to a computer-implemented system that matches transportation provider devices with transportation requests of requester devices. In particular, a transportation matching system can communicate with requester devices associated with requesters of transportation and provider devices associated with providers of transportation. The transportation matching system can use location information and availability information, for example, from provider devices to match the provider devices to transportation requests received from requester devices.

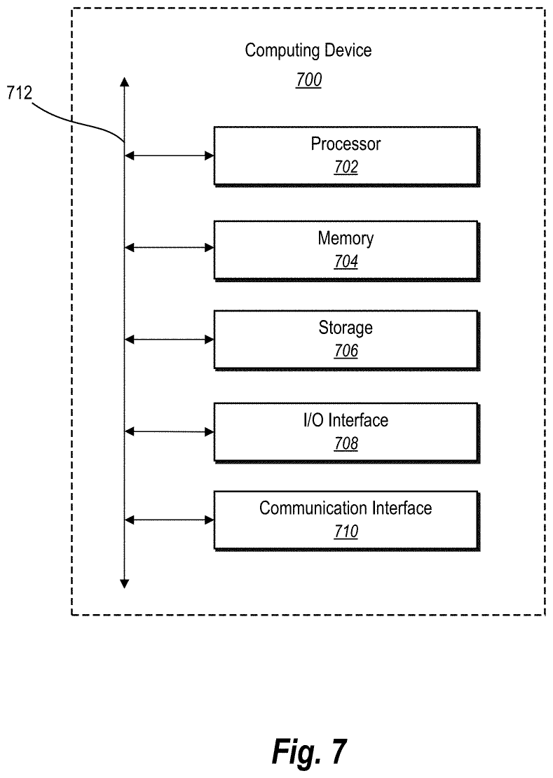

As used herein, the term “provider device” refers to a computing device associated with a provider vehicle (e.g., which allows the provider to receive transportation requests). For example, a provider device may refer to a separate mobile device, such as a laptop, smartphone, or tablet associated with the transportation provider, though a provider device may be any type of computing device as further explained below with reference to FIG. 7. A provider device may be a subcomponent of a vehicle computing system, such as a vehicle computing system for autonomous vehicles. A provider device can also include various sensors, such as a GPS locator, an inertial measurement unit, an accelerometer, a gyroscope, a magnetometer, and/or other sensors that the transportation matching system can access to obtain information (e.g., location information).

As used herein, the terms “fleet vehicle” and “provider vehicle” refers to a vehicle for fulfilling transportation requests by transporting a requester from a pick-up location to a drop-off location. A provider vehicle can include a vehicle driven by a transportation provider (or simply “provider”), which is a human operator. A provider vehicle can also include an autonomous vehicle—that is, a self-driving vehicle that includes computer components and accompanying sensors for driving without manual-provider input from a human operator. When a provider vehicle is an autonomous vehicle, the provider vehicle may include additional components such as location components, one or more sensors by which the autonomous vehicle navigates, and/or other components necessary to navigate without a human operator (or with minimal interactions by a human operator). Additionally, a provider vehicle can include a single vehicle in a plurality of vehicles maintained and managed as a group (or “fleet”) by a transportation matching system. A fleet of vehicles can include rental vehicles, autonomous vehicles, and/or driver owned/operated vehicles managed by a transportation matching system.

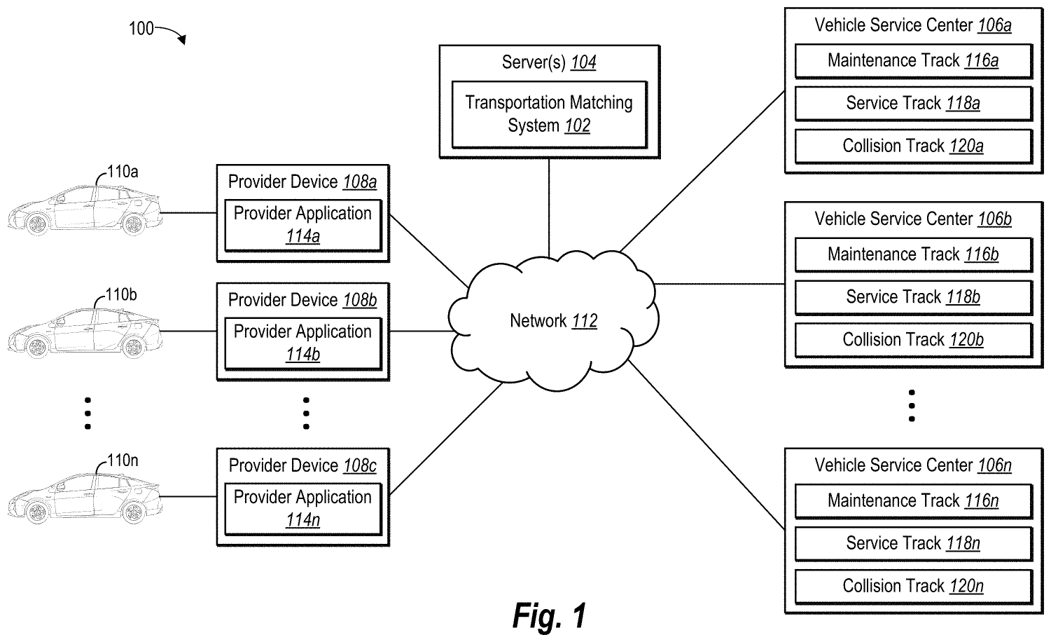

Turning now to the figures, FIG. 1 illustrates a schematic diagram of an environment for implementing a vehicle service matching system 100 (or “service matching system 100”) in accordance with one or more embodiments. This disclosure provides an overview of the service matching system 100 with reference to FIG. 1. As shown, FIG. 1 illustrates a service matching system 100 that includes a transportation matching system 102 implemented on one or more server(s) 104. The service matching system 100 further includes vehicle service centers 106a-106n and provider devices 108a-108n associated with provider vehicles 110a-110n. As further shown in FIG. 1, the transportation matching system 102 can communicate with the vehicle service centers 106a-106n and the provider devices 108a-108n via a network 112. Furthermore, as illustrated, the provider devices 108a-108n include provider applications 114a-114n. Additionally, the vehicle service centers 106a-106n include maintenance tracks 116a-116n, service tracks 118a-118n, and collision tracks 120a-120n (or a different number or type of tracks).

As shown in FIG. 1, the service matching system 100 can intelligently match the provider vehicles 110a-110n to the vehicle service centers 106a-106n to facilitate servicing the provider vehicles 110a-110n. Specifically, the service matching system 100 can maintain, or otherwise identify, servicing information associated with the provider vehicles 110a-110n to determine when each of the provider vehicles 110a-110n is due for one or more services that the vehicle service centers 106a-106n perform. In response to determining that a provider vehicle is due for a particular service, the service matching system 100 can notify a provider device associated with the provider vehicle that the provider vehicle is due for the service.

In one or more embodiments, the service matching system 100 can utilize the transportation matching system 102 to identify information about a provider vehicle for determining when to schedule a service time for the provider vehicle. For instance, the service matching system 100 can use the transportation matching system 102 to determine a location of the provider vehicle, a current transportation route involving the provider vehicle, and any future scheduled transportation routes. To illustrate, the transportation matching system 102 can communicate with the provider device associated with the provider vehicle via the network 112 to obtain such information.

Furthermore, the service matching system 100 can determine a vehicle service center near a provider vehicle for servicing the provider vehicle. For example, the service matching system 100 can utilize the transportation matching system 102 to communicate with a vehicle service center near the provider vehicle (e.g., based on a location of the associated provider device) via the network 112. Additionally, the service matching system 100 can obtain availability information for services from the vehicle service center to determine a service time for the provider vehicle. The service matching system 100 can then provide (e.g., using the transportation matching system 102) information about the service time to the provider device associated with the provider vehicle.

In addition to scheduling service times for provider vehicles, the service matching system 100 can also monitor statuses of the provider vehicles 110a-110c while the provider vehicles 110a-110c are at the vehicle service centers 106a-106n. In particular, the service matching system 100 can identify a current location (e.g., track or station within a track) of provider vehicles, services being performed on provider vehicles, etc. by communicating with the vehicle service centers 106a-106n. The service matching system 100 can then provide information about the current statuses of the provider vehicles to corresponding provider devices and/or send requests for permission to perform additional services to the provider devices. To illustrate, the service matching system 100 can send a notification/request to a provider device (e.g., via a corresponding provider application) in response to determining to dispatch a provider vehicle from a maintenance track to a service track or a collision track.

In one or more additional embodiments, the service matching system 100 can communicate with provider vehicles that are autonomous vehicles in connection with matching the provider vehicles to service times. For example, the service matching system 100 can determine a service time for a service that is due for an autonomous vehicle and then direct the autonomous vehicle to a vehicle service center at the service time. Once the service is complete, the service matching system 100 can begin matching new transportation requests to the autonomous vehicle.

In one or more embodiments, the service matching system 100 can determine whether to perform additional services on provider vehicles based on vehicle data obtained from the provider vehicles in tracks of the vehicle service centers. For example, the vehicle service centers can include devices that capture vehicle data or receive input of vehicle data from technician devices. The service matching system 100 can use the vehicle data to identify one or more additional issues and one or more additional services in one or more of the tracks to fix the identified issue(s). The service matching system 100 can dispatch provider vehicles with the one or more additional issues to the one or more other tracks based on permissions received from the provider devices.

As mentioned previously, the provider devices 108a-108n respectively include provider applications 114a-114n. In some embodiments, the provider applications 114a-114n comprise web browsers, applets, or other software applications (e.g., native applications) available to the provider devices 108a-108n. Additionally, in some instances, the service matching system 100 provides data packets including instructions that, when executed by the provider devices 108a-108n, create or otherwise integrate provider applications 114a-114n within an application or webpage.

The network 112 shown in FIG. 1 may include one or more networks and may use one or more communication platforms or technologies suitable for transmitting data and/or communication signals. In some embodiments, the network 112 includes a cellular network. The network 112 can additionally include the Internet or World Wide Web. Additionally or alternatively, the network 112 can include various other types of networks that use various communication technologies and protocols, such as a corporate intranet, a virtual private network (“VPN”), a local area network (“LAN”), a wireless local network (“WLAN”), a wide area network (“WAN”), a metropolitan area network (“MAN”), or a combination of two or more such networks.

As shown, FIG. 1 illustrates that the transportation matching system 102 is implemented on server(s) 104 as part of the service matching system 100. In particular, the transportation matching system 102 provides functionality to match transportation requests received from requester devices to provider devices. In one or more embodiments, the transportation matching system 102 can also include functionality for matching provider devices to one or more vehicle service centers in connection with servicing provider vehicles. The transportation matching system 102 can also include functionality for providing information to service technicians (e.g., via technician devices) and for managing service statuses of provider vehicles in vehicle service centers.

In one or more alternative embodiments, the service matching system 100 may utilize another system (e.g., additional servicers) to implement some functionality for matching provider vehicles to vehicle service centers and managing service statuses of the provider vehicles. For instance, the service matching system 100 can include another system that communicates with the transportation matching system 102 to send data to and receive data from provider devices. In other embodiments, the service matching system 100 can implement at least some of the functionality of the service matching process on provider devices. While FIG. 1 illustrates one configuration of the service matching system 100, the service matching system 100 may include additional or fewer components in connection with service matching and monitoring of provider vehicles. Accordingly, references herein describing the service matching system 100 performing one or more operations associated with matching provider vehicles to vehicle service centers may include the transportation matching system 102 or another system performing those operations.

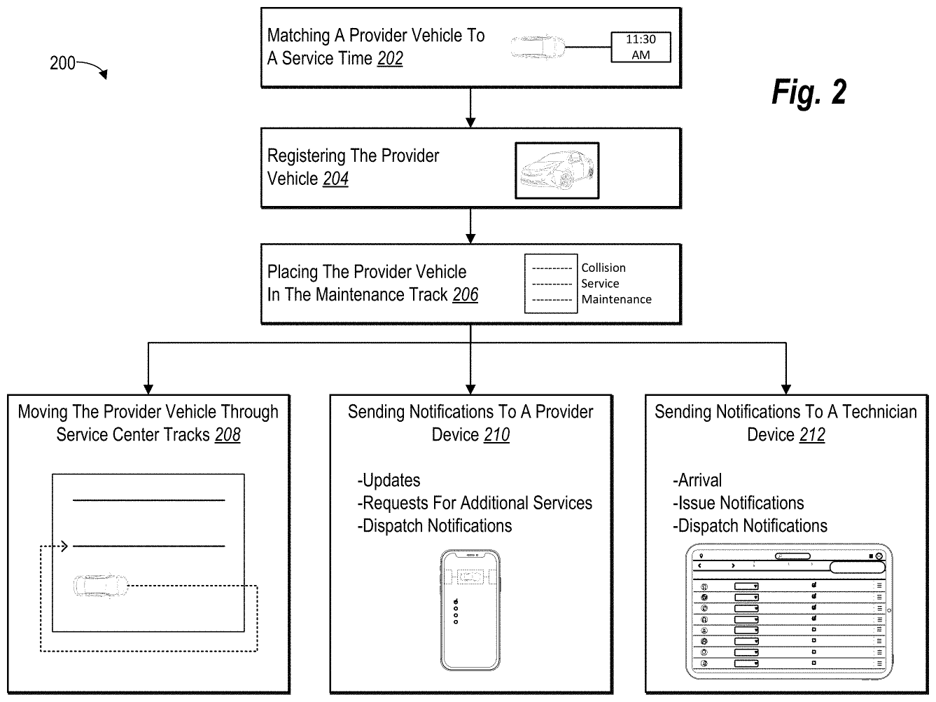

As briefly described above, the service matching system 100 can schedule and manage services for provider vehicles associated with a transportation matching system. FIG. 2 illustrates an overview of a process for matching and performing services for a provider vehicle in accordance with one or more embodiments. In particular, FIG. 2 illustrates block diagrams associated with a series of acts 200 associated with scheduling and performing services for a provider vehicle, as well as for notifying a provider device and/or a technician device based on the services.

For example, FIG. 2 illustrates that the series of acts 200 includes an act 202 of matching a provider vehicle to a service time. In particular, the service matching system 100 can leverage a transportation matching system (e.g., transportation matching system 102) to match a provider vehicle to a time slot for servicing the provider vehicle at a vehicle service center based on availability of the vehicle service center in conjunction with availability of the provider vehicle. For instance, the service matching system 100 can determine a service time during which a vehicle service center has availability and at which the provider vehicle can be present at the vehicle service center. Additionally, the service matching system 100 can determine a service time based on a request by a provider device to join a waitlist.

To illustrate, in one or more embodiments, the service matching system 100 can first determine that the provider vehicle is due for a particular service type. For example, the service matching system 100 can access a profile of the provider, provider device, or provider vehicle that includes information about a most recent maintenance or service performed on the provider vehicle. The service matching system 100 can alternatively determine that the provider vehicle requires a service based on other information, such as if the provider takes the provider vehicle in for a tune-up or repair, and the service matching system 100 determines that the provider vehicle requires (or would benefit from) another service. Similarly, the service matching system 100 can determine a need for service by monitoring the provider vehicle (e.g., tracking engine performance) or based on user input (e.g., user entry of a noise or performance problem via a user interface).

The service matching system 100 can then identify a vehicle service center that can perform the service type on the provider vehicle. In particular, the service matching system 100 can be associated with a number of different vehicle service centers. The service matching system 100 can identify a vehicle service center closest to a location of the provider vehicle based on location data obtained from the profile or from a provider device associated with the provider vehicle. In some cases, the service matching system 100 can store a preferred vehicle service center in a profile associated with a provider device such that future service matches utilize the preferred vehicle service center. Additionally, the service matching system 100 can update a vehicle service center stored with a profile based on new location data or preferences associated with the provider device (e.g., if a provider relocates).

After identifying a service type and a vehicle service center for the provider vehicle, the service matching system 100 can determine a service time for performing the service type at the vehicle service center. For instance, the service matching system 100 can determine an estimated availability of the vehicle service center based on a current service status of provider vehicles at the vehicle service center. The service matching system 100 can determine an availability in one or more stations of a track according to station status(es) indicating a progression of one or more vehicles through the one or more stations. To illustrate, the service matching system 100 can obtain status information for a station using one or more sensors (e.g., cameras, motion sensors, weight sensors) or information from one or more technician devices based on interactions by technicians with user interfaces.

The service matching system 100 can match the provider vehicle to a service time based on the estimated availability of the vehicle service center and one or more transportation requests assigned to the provider device associated with the provider vehicle. The service matching system 100 can use status information for a station to determine when the station is available or when the station is likely to be available. For example, the service matching system 100 can utilize a forecasting model (e.g., machine-learning model, regression model, time series model) that predicts station availability based on the current status of a station and historical information associated with the station. The service matching system 100 can then determine an amount of time until the provider vehicle should arrive at the corresponding track/station for servicing.

In one or more additional embodiments, the service matching system 100 can assign additional transportation requests to a provider device associated with a provider vehicle based on a determined service time for the provider vehicle. In particular, the service matching system 100 can assign one or more additional transportation requests within a proximity of the vehicle service center based on an estimated completion time associated with the transportation request(s) and an amount of time until the determined service time. For example, the vehicle service center can assign transportation requests that have drop-off locations within a predefined proximity (e.g., a five-mile radius) of the vehicle service center to allow the provider vehicle to arrive at the vehicle service center at (or before) the service time. Alternatively, the vehicle service center may assign transportation requests with drop-off locations that have an estimated travel time distance to the vehicle service center that allows the provider vehicle to arrive at the vehicle service center at (or before) the service time.

Although FIG. 1 illustrates the service matching system 100 providing vehicle maintenance services for provider vehicles associated with the transportation matching system 102, in one or more embodiments, the service matching system 100 can provide services to other vehicles, as well. For instance, the service matching system 100 can match vehicles that are not associated with provider devices to one or more vehicle service centers for servicing. The service matching system 100 can also communicate with user devices associated with the other vehicles via a separate client application (e.g., a requester application associated with the transportation matching system 102).

FIG. 2 illustrates that the series of acts 200 also includes an act 204 of registering the provider vehicle. Specifically, when the provider vehicle arrives at the vehicle service center for servicing, the service matching system 100 can register the provider vehicle for performing one or more services. For instance, the service matching system 100 can register the provider vehicle in a computing system that manages a schedule of services to perform on one or more provider vehicles. Registering the provider vehicle can also allow the service matching system 100 to monitor a service status of each provider vehicle that the vehicle service center is servicing. For example, registering the provider vehicle can include storing information about the provider vehicle (e.g., ownership information, make, model, year, license, state registration, vehicle identification number) with service information (e.g., the service status).

As mentioned above, the service matching system 100 can register the vehicle automatically based on a variety of approaches. In some embodiments, the service matching system 100 detects location information corresponding to the provider device (e.g., GPS location data). When the provider device comes within a threshold distance of the service center (e.g., 100 feet), the service matching system 100 can automatically register the vehicle.

Similarly, in some embodiments, the act 204 of registering the provider vehicle can include capturing a digital image of the vehicle. For instance, the service matching system 100 can utilize a camera device to capture images of vehicles when they approach the vehicle service center. Utilizing image recognition technology (e.g., matching car make and model and/or matching license plate number), the service matching system 100 can determine that a digital image portrays a vehicle corresponding to a service time. In response, the service matching system 100 can register the vehicle.

In one or more embodiments, the service matching system 100 can utilize digital images captured at the time of registration to identify maintenance needs. For example, the service matching system 100 can analyze a digital image to identify dents, paint scratches, worn tires, or other issues. In some embodiments, the service matching system 100 compares previous digital images of a vehicle (e.g., from previous service appointments) with a current digital image to identify maintenance issues (e.g., to identify scratches).

Additionally, FIG. 2 illustrates that the series of acts 200 includes an act 206 of placing the provider vehicle in the maintenance track of the vehicle service center. In particular, the service matching system 100 can direct the provider vehicle to enter a single entry point of the maintenance track. To illustrate, the service matching system 100 can provide a notification to a provider device for a provider to drive the provider vehicle into the maintenance track. Alternatively, the service matching system 100 can provide a notification to a technician device for a service technician to drive the provider vehicle into the maintenance track.

Although FIG. 2 illustrates dispatching the vehicle in the maintenance track, in some embodiments, the service matching system 100 can dispatch the vehicle to an alternative track. For example, if a vehicle needs a paint job, the service matching system 100 can dispatch the vehicle directly to the collision track. Similarly, the service matching system 100 can dispatch the vehicle to the service track.

FIG. 2 illustrates that the series of acts 200 can further include additional acts once the provider vehicle has entered the maintenance track. For example, the series of acts 200 can include an act 208 of moving the provider vehicle through service center tracks. Specifically, the service matching system 100 can perform maintenance services on the provider vehicle while the provider vehicle is in the maintenance track. During, or after, performance of one or more maintenance services on the provider vehicle, the service matching system 100 can also determine that the provider vehicle requires (or would benefit from) additional services not performed in the maintenance track. The service matching system 100 can then determine to dispatch the provider vehicle to one or more of the other tracks (i.e., the service track and/or the collision track).

In one or more embodiments involving an autonomous provider vehicle, the service matching system 100 can send instructions to the provider vehicle to move the provider vehicle through the service center tracks. Specifically, after a particular service is complete at a station in a track, the service matching system 100 can send instructions to the provider vehicle that cause the provider vehicle to move to the next station and/or track. To illustrate, the service matching system 100 can send instructions to the provider vehicle to move from a first maintenance station to a second maintenance station. Additionally, the service matching system 100 can send instructions to the provider vehicle to move from a final maintenance station to an entry point of a service track in response to the service matching system 100 determining to dispatch the provider vehicle to the service track.

Additionally, FIG. 2 illustrates that the series of acts 200 can include an act 210 of sending notifications to a provider device. In particular, as mentioned previously, the service matching system 100 can communicate with a provider device associated with a provider vehicle. The service matching system 100 can send notifications indicating information about the provider vehicle and/or requesting information from the provider device. For instance, the service matching system 100 can send updates regarding a current service status of the provider vehicle such as a current service, an estimated completion time, or additional services yet to be performed. The service matching system 100 can also send requests for additional services that the service matching system 100 would like to perform on the provider vehicle. Additionally, the service matching system 100 can send dispatch notifications indicating that the service matching system 100 has dispatched the provider vehicle to another track.

FIG. 2 also illustrates that the series of acts 200 can include an act 212 of sending notifications to a technician device. In one or more embodiments, one or more technicians associated with the vehicle service center can use one or more technician devices while servicing provider vehicles. The service matching system 100 can thus send notifications associated with services for a provider vehicle to one or more technician devices to indicate a progress or issues related to the provider vehicle. For instance, the service matching system 100 can provide a notification to a technician device indicating an arrival of a provider vehicle (e.g., at the service center, at a particular track, or at a particular station within a track). The service matching system 100 can also provide one or more notifications of issues (e.g., problems such as broken, worn, or damaged vehicle components). The service matching system 100 can also provide dispatch notifications indicating to dispatch a provider vehicle from one track to another.

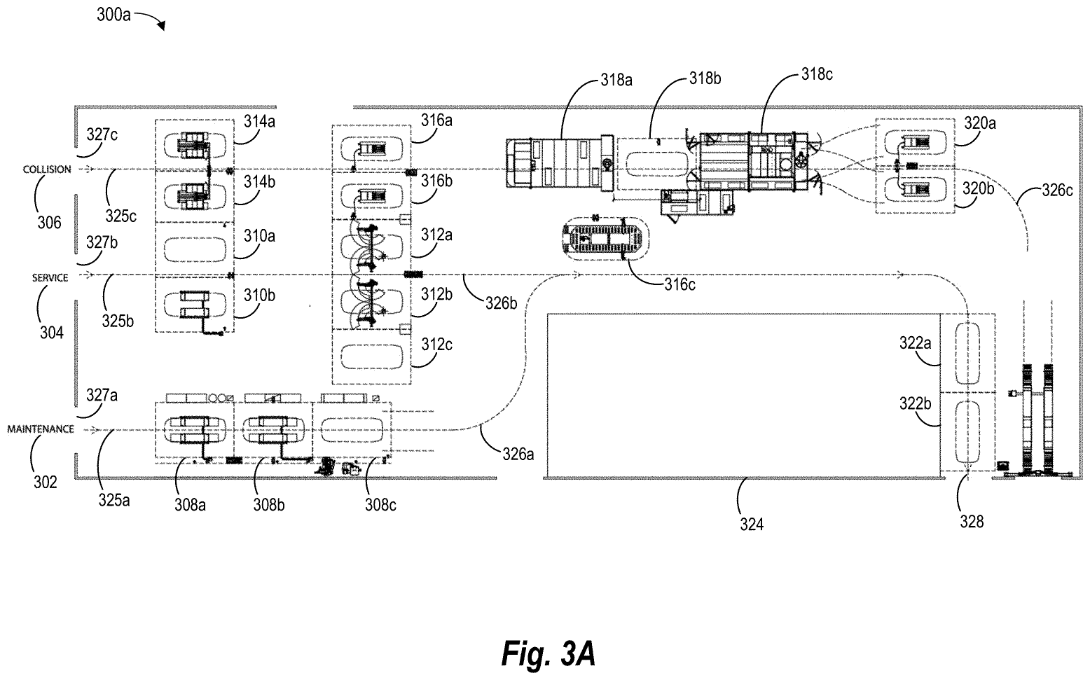

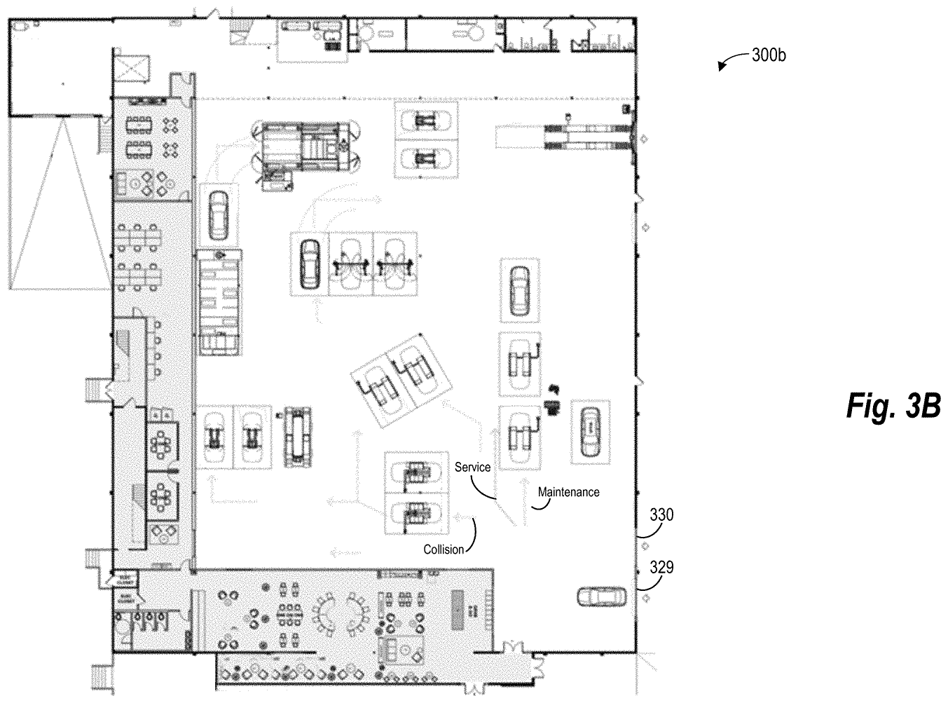

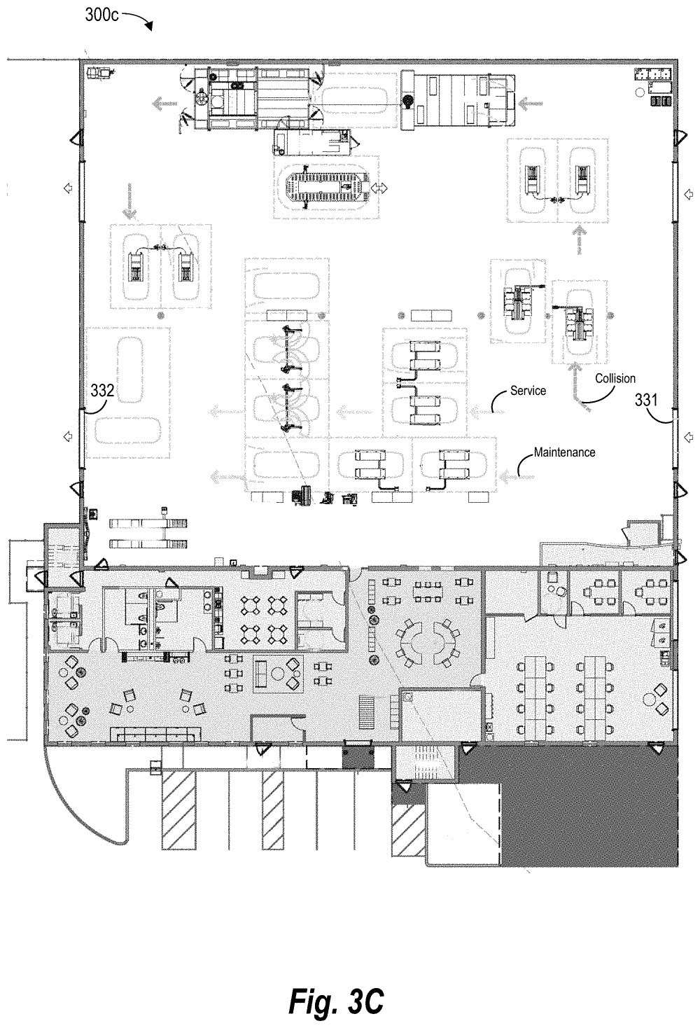

FIG. 3A illustrates a diagram of a vehicle service center 300a associated with the service matching system 100 in accordance with one or more embodiments. In particular, the vehicle service center 300a can perform a variety of services on provider vehicles. Accordingly, the service matching system 100 can match provider vehicles to service times at the vehicle service center 300a to perform one or more of the services on each of the provider vehicles that the vehicle service center 300a provides.

As shown in FIG. 3A, the vehicle service center 300a includes a number of tracks for performing various types of services on provider vehicles. Specifically, the vehicle service center includes a maintenance track 302, a service track 304, and a collision track 306. Each of the tracks includes a number of stations for servicing provider vehicles according to the service types corresponding to each track. Thus, when servicing a provider vehicle, the service matching system 100 can determine whether a service to be performed corresponds to the maintenance track 302, the service track 304, or the collision track 306. The service matching system 100 can then assign or dispatch the provider vehicle to the corresponding track based on the identified service type.

In one or more embodiments, the maintenance track 302 can correspond to a first set of services for performing routing maintenance on provider vehicles. For instance, the first set of services can include, but is not limited to, oil changes, tire rotations, filter replacements, or other simple repairs/replacements. Additionally, in one or more embodiments, the service track 304 can correspond to a second set of services that include services not performed in the maintenance track 302. For example, the second set of items can include, but is not limited to, repairs on broken, worn, or damaged vehicle components such as brakes, engine components, vehicle interior components, or similar repairs. In one or more embodiments, the collision track 306 can correspond to a third set of services associated with vehicle body and collision services. To illustrate, the third set of services can include, but is not limited to, damage to vehicle bodies or structures, dent repair, paint, and touch up services.

Although the above description provides examples of services for each of the maintenance track 302, service track, 304 and collision track 306, the specific services provided within each track may be different than those described. For instance, the maintenance track 302 may correspond to services that typically take less than a threshold amount of time, while the service track 304 may correspond to services that typically take at least the threshold amount of time. In yet other examples, the services corresponding to each track may be based on other criteria, such as the tools required to perform each service, the areas of the vehicle corresponding to each service, or the abilities of the technicians in each lane.

As briefly mentioned, each track can include one or more stations for performing various services or partial services. To illustrate, the maintenance track 302 of FIG. 3A includes a plurality of maintenance stations 308a-308c. In one or more embodiments, each of the maintenance stations 308a-308c corresponds to a different service or partial service. For example, a first maintenance station 308a can correspond to a first maintenance service (e.g., changing oil/air filters), a second maintenance station 308b can correspond to a second maintenance service (e.g., filling or rotating tires), and the third maintenance station 308c can correspond to a third maintenance service (e.g., checking and filling other vehicle fluids). Additionally, the stations can perform different operations based on the tools required to perform the corresponding maintenance services, based on the provider vehicles, and/or based on technicians assigned to the stations. In another example, the first maintenance station 308a can correspond to a preparatory operation that prepares provider vehicles for maintenance services performed at the second maintenance station 308b or the third maintenance station 308c.

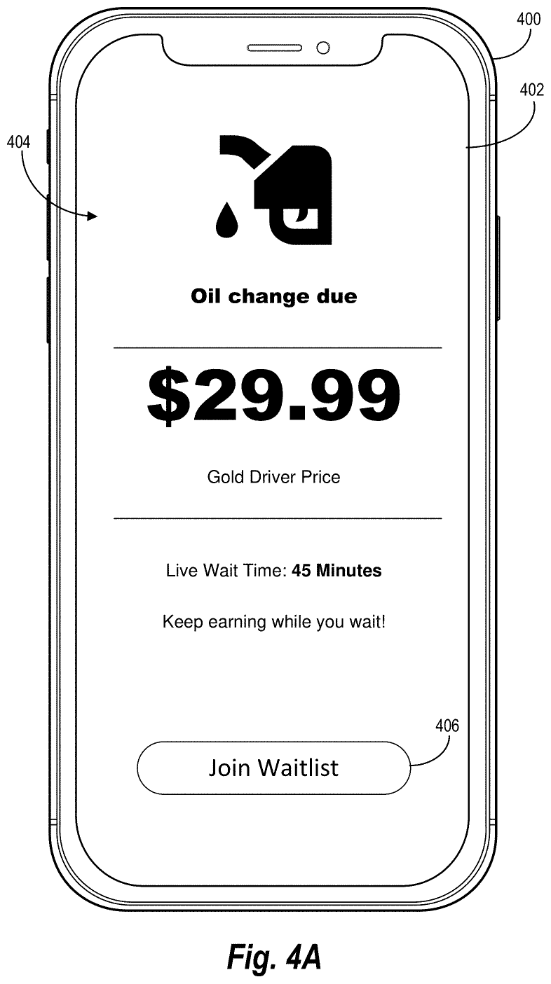

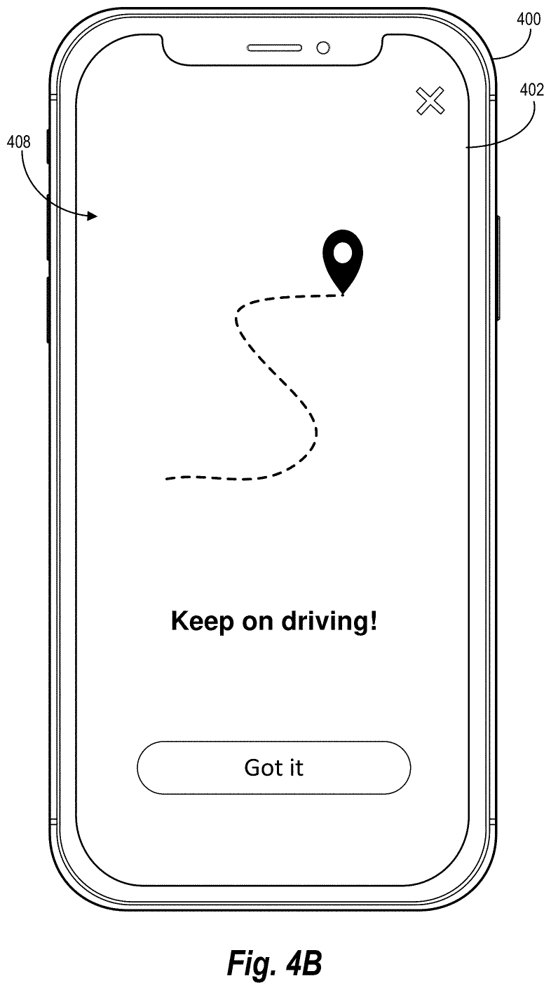

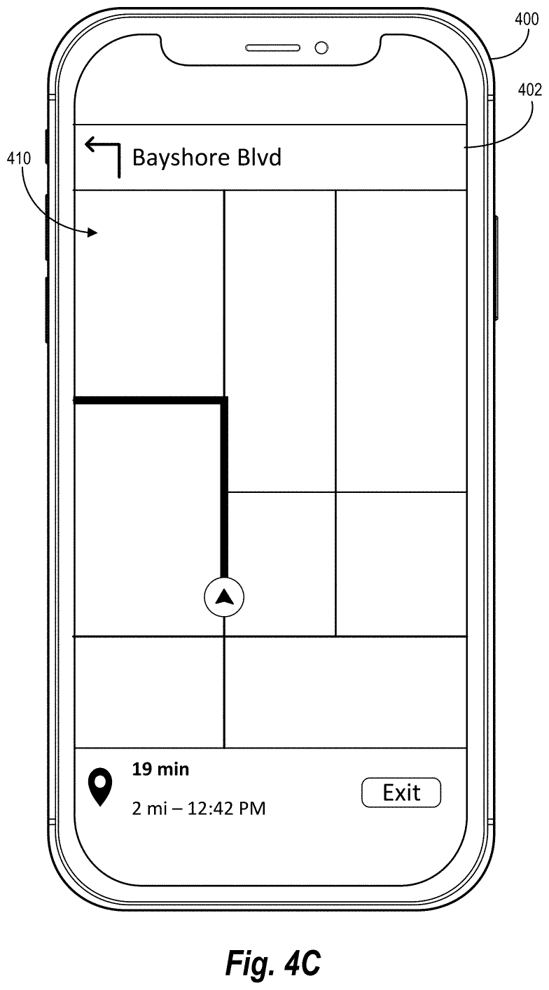

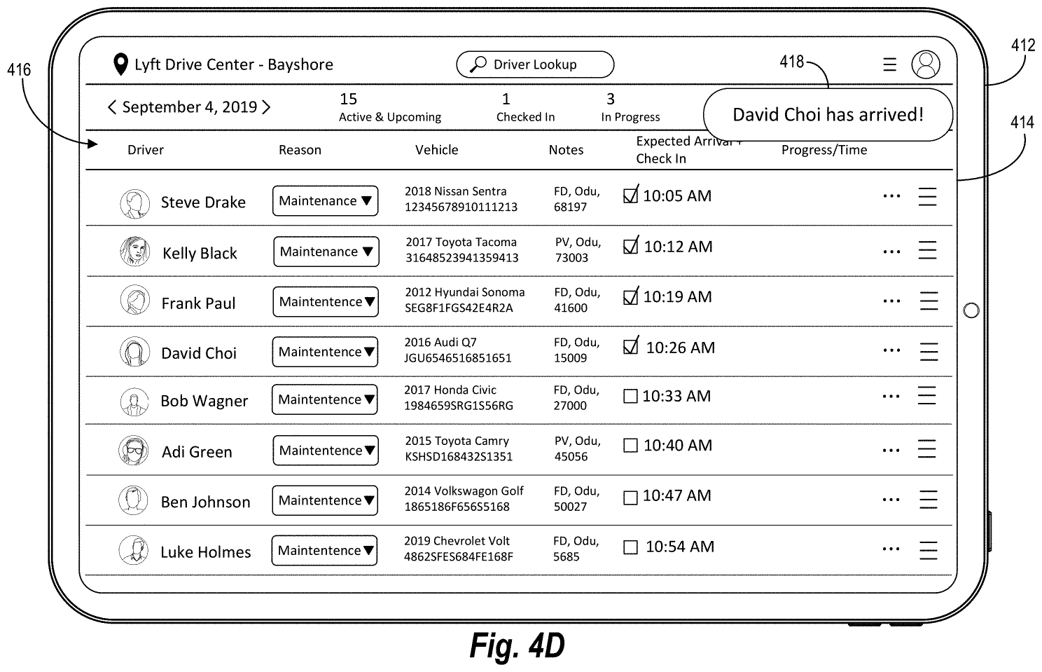

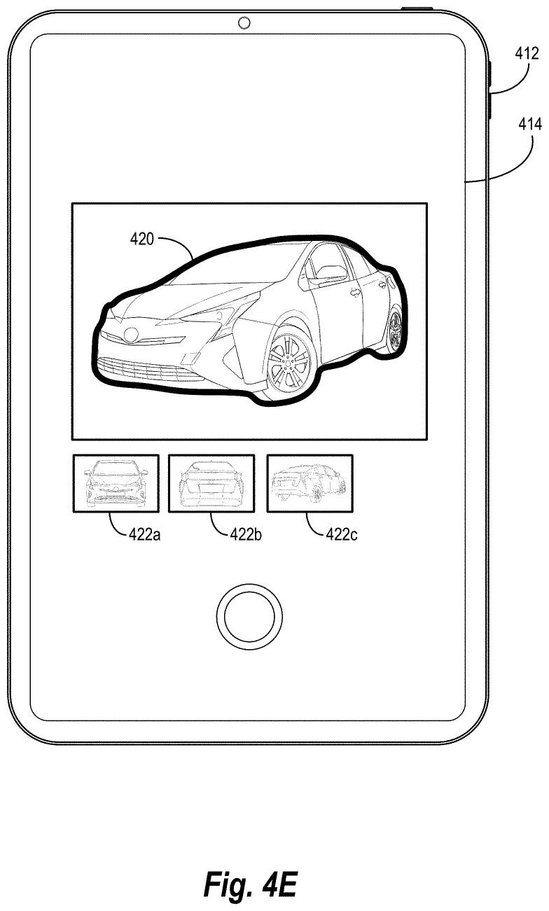

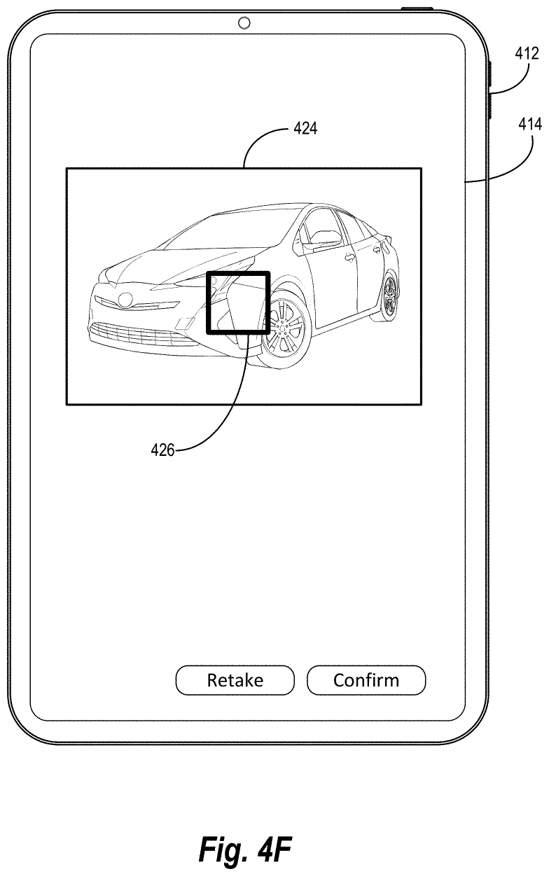

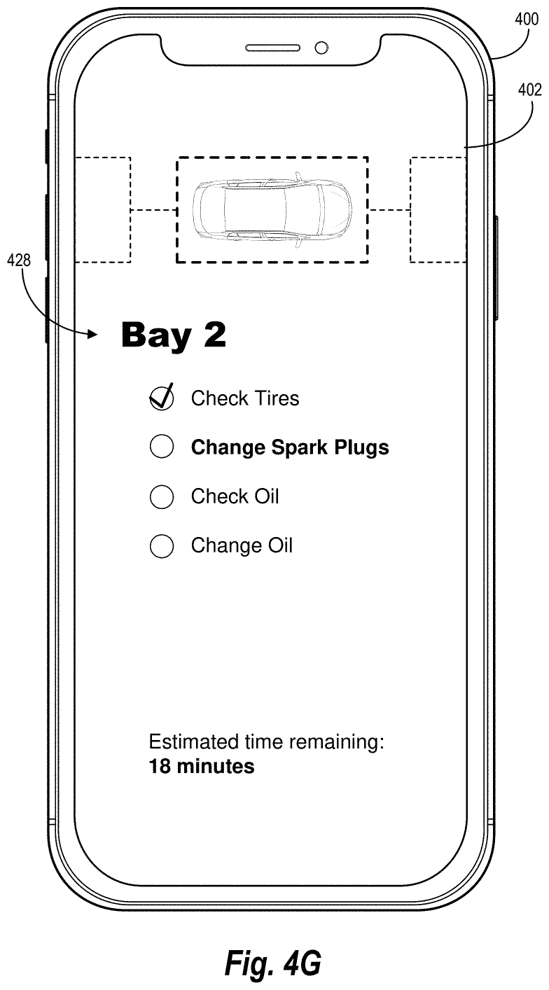

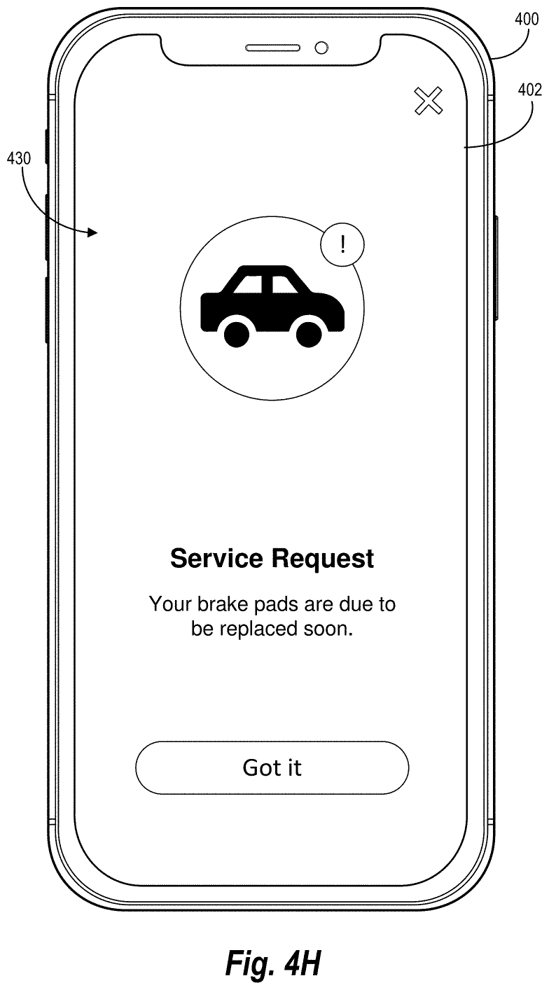

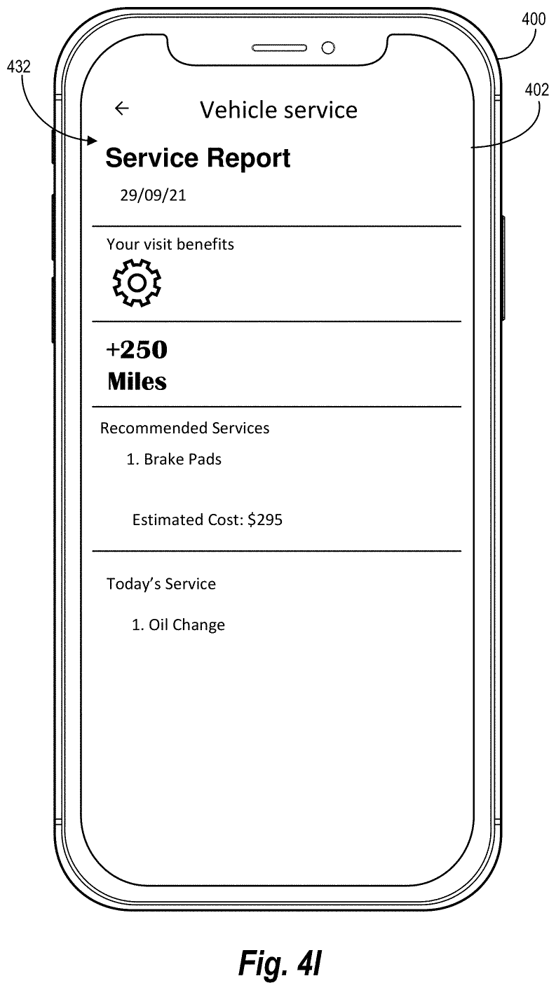

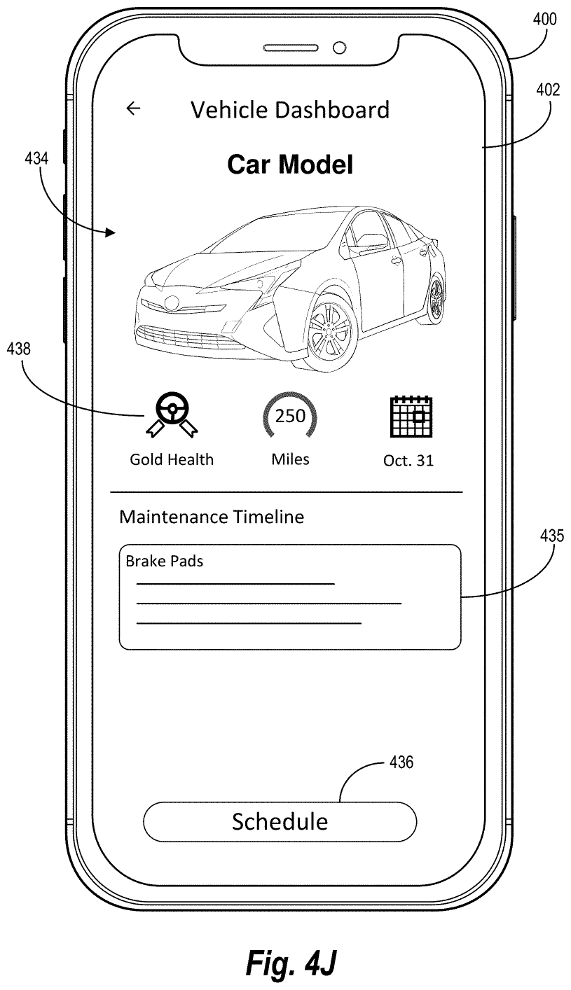

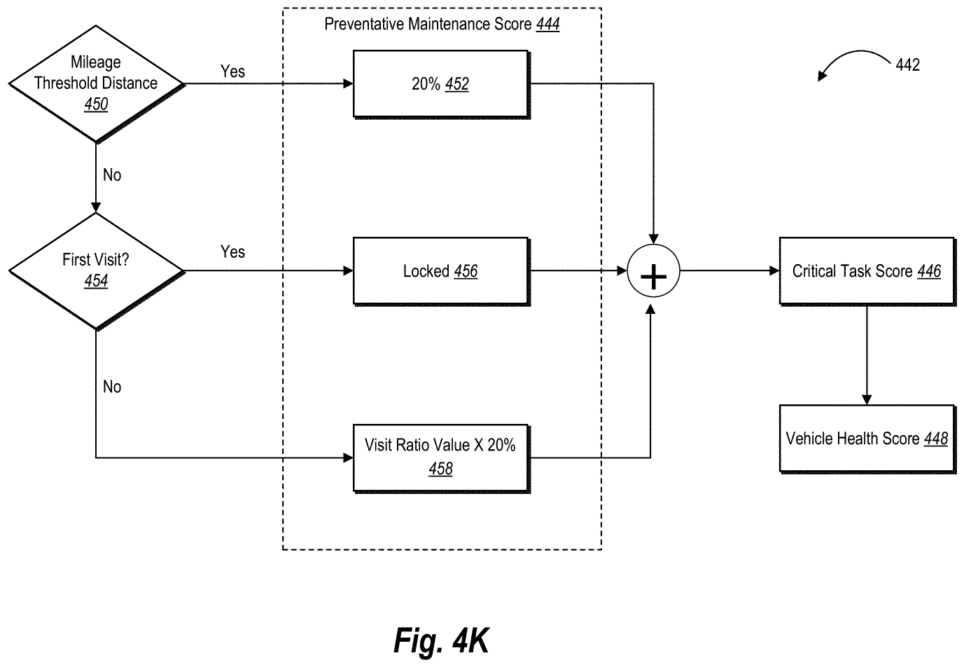

In one or more embodiments, at least one of the maintenance stations 308a-308c includes one or more image capture devices for capturing images of provider vehicles entering the maintenance track 302. The service matching system 100 can utilize the image capture devices to capture images of the provider vehicles at different angles for storing with profiles of the provider vehicles. The service matching system 100 can also capture images or readings of odometers or other measurement devices on provider vehicles for storing with profiles of the provider vehicles. The service matching system 100 can also use the captured images to identify additional issues associated with provider vehicles, as described in more detail below with respect to FIGS. 4E-4F. For example, the service matching system 100 can utilize a technician device or a machine-learning model to indicate possible issues for a provider vehicle within, or based on, the captured images.

FIG. 3A further illustrates that the service track 304 includes a plurality of diagnostic stations 310a-310b and a plurality of service stations 312a-312c. In one or more embodiments, the diagnostic stations 310a-310b correspond to diagnostic services for diagnosing issues with provider vehicles. For example, the service matching system 100 can identify an issue associated with a provider vehicle and then use the diagnostic stations 310a-310b to provide a more in-depth analysis of the identified issue (e.g., what is wrong and what needs to be fixed). The service matching system 100 can also use vehicle data obtained for the provider vehicle in the maintenance track 302 to inform the analysis at the diagnostic stations 310a-310b.

FIG. 3A illustrates that the service track 304 also includes a plurality of service stations 312a-312b for servicing provider vehicles based on diagnoses from the diagnostic stations 310a-310b. To illustrate, after diagnosing an issue associated with a provider vehicle, the service matching system 100 can direct the provider vehicle from a diagnostic station to one of the service stations 312a-312b. The service matching system 100 can then provide the service(s) for fixing the diagnosed issues at the corresponding service station. Furthermore, as shown in FIG. 3A, the maintenance track 302 and the service track 304 can share one or more washing stations (e.g., washing stations 322a-322b) for washing providers after providing services in the maintenance track 302 or the service track 304.

Additionally, FIG. 3A illustrates that the collision track 306 includes a plurality of planning stations 314a-314b, body repair stations 316a-316c, paint stations 318a-318c, re-assembly stations 320a-320b. In one or more embodiments, the planning stations 314a-314b are for planning and preparing provider vehicles for body/collision repair services performed in the body repair stations 316a-316c. Additionally, the body repair stations 316a-316c can include one or more light body repair stations (e.g., body repair stations 316a-316b) and one or more heavy body repair stations (e.g., body repair station 316c). The collision track 306 can include the paint stations 318a-318c for preparing, masking, and painting provider vehicles that have had body repairs. Finally, the collision track 306 can also include one or more re-assembly stations 320a-320b for re-assembling any provider vehicles that have been disassembled in any of the previous stations.

In one or more embodiments, the vehicle service center 300a includes a number of stations in each track based on estimated times associated with performing services within each station. For example, if diagnostic services in the service track typically take fifteen minutes to perform, and services based on the diagnoses typically take about thirty minutes to perform, the vehicle services center can include enough service stations to accept vehicles from the diagnostic stations. Additionally, the vehicle service center 300a can include a physical arrangement of stations within each track, and in separate tracks, that allows for technicians to easily move from one station to another, or from one track to another, to perform different services in the different stations and tracks. The service matching system 100 can thus easily manage the schedule of technicians at each station and in each track to reduce or prevent excessive downtime in each station.

Furthermore, FIG. 3A illustrates that each track is a linear track that includes a single entry point (e.g., entry points 325a-325c corresponding to the separate tracks) and a single exit point (e.g., exit points 326a-326c corresponding to the separate tracks) following a linear progression through the tracks. In particular, as shown, each of the maintenance track 302, the service track 304, and the collision track 306 includes an entry point that follows a linear progression of stations that lead to an exit point of the corresponding track. To illustrate, the maintenance track 302 includes a linear progression through each of the maintenance stations 308a-308c. When a provider vehicle enters the maintenance track 302 at the first maintenance stations 308a, the provider vehicle passes through each of the following stations until exiting from the third maintenance station 308c.

Although the tracks include individual exit points 326a-326c, as shown in FIG. 3A, the service center itself (e.g., the building housing the service center) has a single building exit 328. In some embodiments, the service center has multiple structure exits. For example, in some embodiments, the service center can include one structural exit for each track or some other number of structural exits (e.g., 2 or 4).

Furthermore, while FIG. 3A illustrates separate building entrances (a first entrance 327a, a second entrance 327b, and a third entrance 327c) corresponding to each entry point for each track, respectively, a building that includes the tracks can have a single building entrance that leads to the entry points of the separate tracks. For example, FIG. 3B illustrates an embodiment of a vehicle service center 300b that includes a single building entrance 329 prior to entry points of each track and a single building exit 330 after the tracks. Additionally, FIG. 3C illustrates another alternative embodiment of a vehicle service center 300c having a single building entrance 331 and a single building exit 332 corresponding to the various tracks. As shown, the interior layout of each vehicle service center, and the corresponding maintenance track, service track, and collision track, can also vary based on the available space and shape of the building. In at least some implementations, some or all of the tracks may also be outside a building, such that the entry points and exit points for each track are open to a parking lot or other exterior structure.

Additionally, while each track may include more than one station at each step along the track (e.g., more than one diagnostic station or more than one service station), each provider vehicle entering the track passes through a single station at each step before progressing to the next step. For example, the service track 304 includes a linear progression starting at an entry point, progressing through a series of stations (e.g., a diagnostic station 310a followed by a service station 312b), and out an exit point. Similarly, the collision track 306 includes a linear progression starting at an entry point, progressing through a series of stations (e.g., a planning station 314b, then a body repair station 316a, then the paint stations 318a-318c, and lastly a re-assembly station 320b), and out an exit point. Thus, for an individual provider vehicle, each track is a linear track that starts at a single entry point and ends at a single exit point.

Additionally, while FIG. 3A illustrates that each track includes a specific number of stations for corresponding services, the tracks may each include a different number of stations than those illustrated. For example, a vehicle service center may include a plurality of maintenance tracks, each of which includes a single entry point leading to a plurality of maintenance stations and out a single exit point. Similarly, a vehicle service center may include any number of service tracks and/or collision tracks following a similar progression as illustrated in FIG. 3A for each track. Additionally, each track may include more or fewer stations that each provide different services than those described in relation to FIG. 3A.

In addition to a plurality of tracks for providing services, the vehicle service center 300a can include a location for providers to stay while their vehicles are in one or more of the tracks. For example, FIG. 3A illustrates that the vehicle service center 300a includes an office area 324 where providers can wait until their respective provider vehicles have exited one or more tracks. In one or more embodiments, the service matching system 100 can notify a provider device of a location of the office area 324 (e.g., by providing a map of the vehicle service center) once the service matching system 100 has registered the provider vehicle and placed the provider vehicle in the maintenance track.

The service matching system 100 can also notify the provider device of updates, service status, etc., as previously mentioned, while the provider is in the office area 324 (or another location if the provider does not stay at the vehicle service center 300a). As mentioned previously, the service matching system 100 can provide a request to the provider device of a provider vehicle if the service matching system 100 determines to dispatch the provider vehicle to another track. Additionally, the service matching system 100 can also provide a notification to the provider device indicating completion of one or more services on the provider vehicle.

In some embodiments, the service station can dispatch provider vehicles, manage machines, and manage display devices, as described in VEHICLE SERVICE CENTER DISPATCH SYSTEM, U.S. patent application Ser. No. 16/727,715; INTELLIGENT MANAGEMENT OF ONE OR MORE MACHINES OF A VEHICLE SERVICE CENTER, U.S. patent application Ser. No. 16/727,746; and INTELLIGENT MANAGEMENT OF ONE OR MORE DISPLAY DEVICES OF A VEHICLE SERVICE CENTER, U.S. patent application Ser. No. 16/727,773, which are hereby incorporated by reference, in their entirety, herein.

As mentioned above, the service matching system 100 can provide information (e.g., notifications or requests) to one or more devices in connection with servicing a provider vehicle. In accordance with one or more embodiments, FIGS. 4A-4J illustrate various graphical user interfaces displayed on various devices before, during, and after a service for a provider vehicle. Specifically, FIGS. 4A-4C and 4G-4J illustrate user interfaces displayed on a provider device. Additionally, FIGS. 4D-4F illustrate user interfaces displayed on one or more technician devices. Furthermore, FIG. 4K illustrates a process for determining a vehicle health score for a provider vehicle based on vehicle and maintenance data maintained by the service matching system 100.

In one or more embodiments, the service matching system 100 can communicate with a provider device 400 to provide information to the provider device 400 for a provider vehicle. For example, FIG. 4A illustrates that the service matching system 100 can provide, for display within a graphical user interface in a provider application 402 on a display device of the provider device 400, service information indicating a service that is due for the provider vehicle. As previously mentioned, the service matching system 100 can determine such service information from a profile associated with the provider device 400. To illustrate, the provider device 400 can be associated with a transportation matching system that matches transportation requests from requester devices to the provider device 400. Accordingly, in one or more embodiments, the service matching system 100 can utilize the transportation matching system to obtain profile information for the provider device 400 and/or the provider vehicle.

In one or more embodiments, the service matching system 100 can provide service information 404 indicating a service type that is due for the provider vehicle, as shown in FIG. 4A. Specifically, FIG. 4A illustrates that the provider vehicle is due to have an oil change. The service matching system 100 can determine that the service is due based on a previous service performed for the provider vehicle, a number of miles traveled by the provider vehicle, an amount of time since the last service, information monitored at the provider vehicle, user entry of vehicle conditions or problems via a user interface, or other data associated with the provider vehicle. The service matching system 100 can then recommend a corresponding service to the provider device 400.

The service matching system 100 can also provide information associated with a cost of the recommended service. For example, the service matching system 100 can provide a price for the service based on information in the profile associated with the provider device 400. In one or more embodiments, the service matching system 100 provides a discount to providers that have a higher standing with the transportation matching system. To illustrate, if the provider associated with the provider device 400 has fulfilled a threshold number of transportation requests or has a threshold rating with the transportation matching system, the service matching system 100 can include a discount price in the service information.

Additionally, FIG. 4A shows that the service matching system 100 can also include an estimated current wait time for an available service time for the suggested service. Specifically, the service matching system 100 can use information from a vehicle service center near the location of the provider device 400 to determine the next available service time for the suggested service. To illustrate, the estimated wait time may be based on the number of provider vehicles currently being serviced, the number of vehicles scheduled to be serviced, the types of scheduled maintenance services, and the average amount of time that the vehicle service center takes to perform the suggested service.

As previously described, the service matching system 100 improves estimated wait times for servicing vehicles. In particular, the service matching system 100 can utilize station status information from a number of stations across a number of different tracks to accurately determine progression of vehicles through the tracks and availability of the tracks using various sensors and/or information from technician devices in conjunction with forecasting models. To illustrate, by tracking detailed progress information about all vehicles across all tracks, the service matching system 100 can accurately determine expected wait times and provide real-time information to technician devices and provider devices, which can eliminate unnecessary downtime associated with a particular maintenance service or sequence of maintenance services.

Furthermore, by performing different types of services within different tracks of the vehicle service center(s), the service matching system 100 can avoid delays and changes in estimated wait times associated with unexpected maintenance issues. For instance, in response to determining that a provider vehicle requires a specific maintenance service while in a particular track, the service matching system 100 can dispatch the provider vehicle to the corresponding track after completing a current maintenance service. This allows the service matching system 100 to avoid holding up the current track to fix the unexpected maintenance issue.

Additionally, the physical arrangement of stations within each track, and across separate tracks can help the service matching system 100 streamline the various services within and across the different tracks. To illustrate, the service matching system 100 can position stations from different tracks associated with a particular technician (or type of technician) near each other while still separating the service flows into different tracks. This can allow the service matching system 100 to generate a streamlined schedule for different maintenance services across different tracks that allows a particular technician to quickly move from one station to another across the different tracks.

In one or more embodiments, the provider device 400 can also display a waitlist element 406. In response to detecting a selection of the waitlist element 406 at the provider device 400, the service matching system 100 can add the provider (or the provider device 400, or the provider vehicle) to a waitlist for the suggested service. To illustrate, the service matching system 100 can add a provider to the end of a queue for an oil change at the vehicle service center in response to a selection of the waitlist element 406 at the provider device 400.

FIG. 4B illustrates that the service matching system 100 can send, to the provider device 400, an indication 408 that the service matching system 100 has added the provider to the waitlist. Accordingly, the provider device 400 can display the indication 408 within the provider application 402 to inform the provider that the provider is on the waitlist. The indication 408 can also include a message such as, “Keep on driving!” indicating that the provider can continue fulfilling transportation requests until the service time.

In addition to notifying the provider device 400 that the provider can continue fulfilling transportation requests until the service time, the service matching system 100 can also schedule additional transportation requests between the time the provider requests to join the waitlist and the service time. For instance, as mentioned previously, the service matching system 100 can schedule transportation requests near the vehicle service center. The service matching system 100 can thus send one or more transportation requests to the provider device 400. If the provider accepts any of the one or more transportation requests sent to the provider device 400, the service matching system 100 can continue to monitor the estimated wait time until the vehicle service center is ready to accept the provider vehicle. To illustrate, the service matching system 100 can determine that the vehicle service center is ready to accept the provider vehicle when an estimated travel time for the provider vehicle to arrive at the vehicle service center is approximately the same (or within a threshold amount of time) of the estimated time before the vehicle service center can begin servicing the provider vehicle.

Additionally, if the service time changes (e.g., based on longer than expected services prior to the estimated service time), the service matching system 100 can continue sending transportation requests to the provider device 400 until the vehicle service center is ready. For example, after the provider fulfills a transportation request, the service matching system 100 can determine whether the estimated travel time of the provider vehicle to the vehicle service center is larger than a threshold amount of time. In one or more embodiments, the threshold amount of time can be dynamic based on whether there are any transportation requests available that the provider can fulfill within the estimated wait time for the service. In other embodiments, the threshold amount of time may be fixed.

Once the service matching system 100 determines that the vehicle service center is ready for the provider vehicle, the service matching system 100 can then route the provider vehicle to the vehicle service center. Specifically, the service matching system 100 can send a notification to the provider device 400 to begin navigating to the vehicle service center. FIG. 4C illustrates that the provider device 400 can display a transportation route 410 (e.g., directions and an estimated travel time) from the current location of the provider device 400 to the location of the vehicle service center. In one or more embodiments, the provider device 400 can automatically display the transportation route within the provider application 402. Alternatively, the provider device 400 can display an option to begin the transportation route to the vehicle service center.

Once the provider vehicle arrives at the vehicle service station, the service matching system 100 can notify a technician of the provider's arrival. For example, FIG. 4D illustrates a technician device 412 including a graphical user interface of a technician application 414 that displays service information relevant to a service technician. In particular, the technician device 412 can display a list 416 of scheduled services for a plurality of providers. The list 416 can include, but is not limited to, photos of the providers, names of the providers, scheduled services, vehicle information, notes, expected arrival time, whether each provider has arrived/registered, and a service status for each provider vehicle.

Additionally, FIG. 4D illustrates that the technician device 412 can display an arrival notification 418 when a provider vehicle arrives at the vehicle service center for servicing. In one or more embodiments, the arrival notification 418 can be a pop-up notification, a tray notification, or other notification. The arrival notification 418 can also include a name of the provider. In addition to displaying the arrival notification 418, the technician device 412 can update the corresponding information displayed with the provider by marking that the provider has checked in (e.g., registered a provider vehicle) at the vehicle service center. For example, the service matching system 100 can provide the user interface illustrated in FIG. 4D based on location information indicating that the provider vehicle is at or near the vehicle service station.

After a provider vehicle has arrived for a service at a vehicle service center, the service matching system 100 can place the provider vehicle in the corresponding track. For example, when a provider vehicle arrives for maintenance, the service matching system 100 can send the provider vehicle to the maintenance track. In one or more embodiments, the service matching system 100 can also provide additional information or functionality to the technician device 412 to assist the technician in performing a service. For example, the technician device 412 can display instructions or a checklist associated with a particular service that the technician is performing.

To illustrate, FIG. 4E shows that the technician device 412 can include functionality for capturing images of provider vehicles that the technician is servicing to store with a profile associated with the provider vehicle and the provider device 400. For example, the technician device 412 can display an image capture interface within the technician application 414 to capture one or more images of a provider vehicle. In one or more embodiments, the technician device 412 displays a capture template 420 that includes an outline or shape of a vehicle from a particular angle to assist a technician in capturing vehicle image from the same angle each time. Each image that the technician device 412 captures (e.g., images 422a-422c) can be based on a different template corresponding to a different perspective of a provider vehicle, such that each image includes a set number of different perspectives of the provider vehicle.

In one or more embodiments, after the technician device 412 captures an image 424 of the provider vehicle using the technician application 414, FIG. 4F illustrates that the technician device 412 can mark at least one portion 426 of the image 424. To illustrate, the technician application 414 can include tools or touch functionality that allows a technician to interact with the image 424 via the technician device 412. In one or more embodiments, the technician device 412 can mark the portion 426 of the image 424 and then store the image 424 with the marked portion 426 with the profile associated with the provider vehicle.

In one or more embodiments, the technician device 412 can also capture data from meters or measurement devices that maintain vehicle data for the provider vehicle. For instance, the technician device 412 can capture an image of an odometer of the provider vehicle or otherwise record an odometer value for the provider vehicle. The technician device 412 can then store the odometer image or odometer value with the profile associated with the provider vehicle.

In one or more additional embodiments, the service matching system 100 can utilize a machine-learning model to capture and/or analyze one or more images of a provider vehicle to identify potential issues for servicing the provider vehicle. Specifically, the service matching system 100 can train the machine-learning model to identify damage to vehicles. The service matching system 100 can also use image analysis to automatically determine vehicle data for the provider vehicle, such as by determining an odometer reading from an image of the odometer of the provider vehicle. The service matching system 100 can then utilize the trained machine-learning model to identify possible damage to a provider vehicle or other maintenance issues while the provider vehicle is in the maintenance track. In one or more embodiments, the machine-learning model can output a marked image or a list of possible issues mapped to portions of the provider vehicle in a manner for technicians to use in servicing the provider vehicle.

As used herein, the term “machine-learning model” refers to a computer representation that can be tuned (e.g., trained) based on inputs to approximate unknown functions. In particular, the term “machine-learning model” can include a model that utilizes algorithms to learn from, and make predictions on, known data by analyzing the known data to learn to generate outputs that reflect patterns and attributes of the known data. For instance, a machine-learning model can include but is not limited to, decision trees, support vector machines, linear regression, logistic regression, Bayesian networks, random forest learning, dimensionality reduction algorithms, boosting algorithms, artificial neural networks (e.g., convolutional neural networks or recurrent neural networks), deep learning, etc. Thus, a machine-learning model makes high-level abstractions in data by generating data-driven predictions or decisions from the known input data. In one or more examples, a machine-learning model can include, or be included in, an object detection network capable of recognizing objects or patterns in digital images (e.g., for identifying vehicle damage).

The service matching system 100 can train a machine learning model to identify particular maintenance needs. For example, the service matching system 100 can gather training data by capturing digital images of vehicles as they progress through maintenance tracks and logging services performed on the vehicle. The service matching system 100 can then utilize these digital images as training inputs and the actual services as ground truth training data. Specifically, the service matching system 100 can analyze a training digital image utilizing a machine learning model, generate a predicted maintenance need, and compare the predicted maintenance need with the actual (ground truth) service performed (e.g., using a loss function). Based on the comparison (e.g., by back-propagating based on the loss), the service matching system 100 can train a machine learning model to accurate determine maintenance needs.

In addition, the service matching system 100 can provide the image 424 and/or other vehicle data to one or more other technician devices in connection with servicing the provider vehicle. For instance, the service matching system 100 can provide the image 424 to a second technician device associated with a technician performing services in a service track. The second technician device can display the image 424 with the marked portion 426 to the technician in the service track for the technician to use in diagnosing and servicing the provider vehicle.

In one or more embodiments, during or after a maintenance service for a provider vehicle, the service matching system 100 can provide updates to a provider device 400 in connection with a current servicing of the provider vehicle. FIG. 4G illustrates the service matching system 100 transmitting a service status 428 for the provider vehicle to the provider device 400 for display within the provider application 402. The service status 428 includes information indicating services that are already completed, a current service (e.g., “Change Spark Plugs” and a corresponding station), and services that are not yet complete to provide an overall workflow of the services being performed on the provider vehicle. The service status 428 can also include an estimated time remaining on the services that the vehicle service center is completing for the provider vehicle. As the vehicle service center completes the services, the service matching system 100 can update the service status 428 to reflect the most recent available information in real-time.

In addition, the service matching system 100 can also determine that the provider vehicle requires (or could benefit from) additional services not performed in the maintenance track. FIG. 4H illustrates that the service matching system 100 can send a service request notification 430 to the provider device 400 for display within the provider application 402. The service request notification 430 can include information indicating the additional service(s) that the provider vehicle may need (e.g., “Your brake pads are due to be replaced soon.”). In one or more embodiments, the service request notification 430 may also include a request for the vehicle service center to perform the additional service(s) during the current visit. If the provider device indicates that the provider has selected an option to accept the request (i.e., the provider gives permission to perform the service), the service matching system 100 can dispatch the provider vehicle to one or more other tracks at the vehicle service center based on the additional service(s).

Alternatively, rather than requesting permission to perform the additional service(s) at the current time, the service matching system 100 may add the additional service(s) to a service report for the provider vehicle. In one or more embodiments, as illustrated in FIG. 4I, the service matching system 100 can generate and provide a service report 432 including service information for the current visit to the vehicle service center. The service report 432 can also include one or more additional recommended services (e.g., based on the identified issues), as well as estimated costs for the additional service(s). Additionally, the service report 432 can include information about savings that the service matching system 100 can provide to the provider based on the regular maintenance of the provider vehicle.

In addition to a service report, the service matching system 100 can provide a vehicle dashboard 434 for the provider vehicle, as shown in FIG. 4J. In particular, the vehicle dashboard 434 can include general information about the provider vehicle (e.g., model, age, mileage), in addition to a maintenance timeline for the provider vehicle. As part of the maintenance timeline, the vehicle dashboard 434 can include one or more maintenance items (e.g., maintenance item 435). The maintenance timeline can include maintenance items that the service matching system 100 has determined that the provider vehicle should receive.

For example, the service matching system 100 can include preventative maintenance items or critical maintenance items in the maintenance timeline. More specifically, the service matching system 100 can identify preventative maintenance items as services that help prevent future issues, such as services defined by a manufacturer's maintenance schedule. To illustrate, the service matching system 100 can indicate that a provider vehicle is due for inspection of the brake pads, replacement of windshield wipers or air filters, or other items that may not be immediately necessary to service but help prevent future issues. According to one or more embodiments, preventative maintenance items may be associated with services performed in the maintenance track.

The service matching system 100 can also identify critical maintenance items as services that impact safety, reliability, and/or uptime (e.g., that are outside of the manufacturer's maintenance schedule or that can cause immediate operational concerns). For instance, the service matching system 100 can identify critical maintenance items based on information obtained during preventative maintenance of a provider vehicle. To illustrate, the service matching system 100 can identify critical maintenance items for a provider vehicle such as replacement of brake pads/rotors. According to one or more embodiments, the critical maintenance items can be associated with services performed in the service track or collision track.

In addition to providing a maintenance timeline, the service matching system 100 can provide a schedule element 436 to schedule one or more of the services that the service matching system 100 suggested in the maintenance timeline. For example, the schedule element 436 can cause the provider device 400 to send a request to the service matching system 100 to schedule a service appointment for the provider vehicle. The provider device 400 can thus provide a scheduling function within the provider application 402 without requiring the provider to access another application or a separate interface (e.g., a messaging application or phone application). The vehicle dashboard 434 can thus provide a quick and easy way for providers to access information about the provider vehicle, the vehicle's standing with the service matching system 100, and to schedule future service appointments from within a single interface.

As mentioned, the service matching system 100 can determine a vehicle health score for a provider vehicle. As used herein, the term “vehicle health score” refers to a value that represents a maintenance status for a provider vehicle. For example, a vehicle health score can indicate whether a provider vehicle is up-to-date on a maintenance schedule and whether the provider vehicle has any outstanding vehicle maintenance issues. FIG. 4J illustrates that the vehicle dashboard 434 can include a score indicator 438 that indicates a vehicle health score of the provider vehicle. As shown, the score indicator 438 can include a non-numerical representation of the health score (e.g., a specific graphic or color of graphic). For example, the score indicator 438 may indicate that the health score falls within a range of numerical values. Alternatively, the score indicator 438 can include a numerical value of the health score visible within the provider application 402.

FIG. 4K illustrates one embodiment of a score process 442 for determining the vehicle health score for a provider vehicle. Specifically, the score process 442 includes first determining a preventative maintenance score 444 and a critical task score 446 for a provider vehicle. The score process 442 then includes combining the preventative maintenance score 444 and the critical task score 446 to generate a vehicle health score 448 for the provider vehicle. As described below, the service matching system 100 can use a variety of algorithms to determine one or more portions of the vehicle health score 448 based on the life of the provider vehicle and/or previous visits to a vehicle service center.

As illustrated in FIG. 4K, the service matching system 100 first determines, at decision box 450, whether the mileage of the provider vehicle meets a threshold distance. For example, the service matching system 100 can determine a mileage of the provider vehicle based on an odometer reading associated with the provider vehicle. Additionally, the service matching system 100 can use a most recent odometer reading from a previous service visit of the provider vehicle at a vehicle service center in combination with transportation data received from the provider vehicle and/or provider device 400 to predict a current odometer reading. For instance, if the provider vehicle has an odometer reading below 30,000 miles, the service matching system 100 can determine that the provider vehicle does meet the threshold distance.

If the mileage of the provider vehicle meets the threshold distance (indicating a relatively new or lightly used vehicle), the service matching system 100 can determine the preventative maintenance score 444 using a first algorithm 452. Specifically, FIG. 4K illustrates that the first preventative maintenance algorithm 452 can include assigning a full possible value of the preventative maintenance score 444 to the provider vehicle. For instance, in one or more embodiments, the service matching system 100 can determine that the preventative maintenance score 444 makes up 20% of the vehicle health score 448 (e.g., based on a weighted value assigned to preventative maintenance tasks based on the importance to the vehicle health relative to critical maintenance tasks). Thus, the first preventative maintenance algorithm 452 can output the full 20% value.

FIG. 4K illustrates that, if the mileage of the provider vehicle does not meet the threshold distance, the service matching system 100 can proceed to decision box 454 to determine whether the provider vehicle has previously visited a vehicle service center. To illustrate, the service matching system 100 can determine whether the provider vehicle has had maintenance or other services at a vehicle service center associated with the service matching system 100. Additionally, the service matching system 100 can determine whether the provider vehicle has visited one or more third-party vehicle service centers associated with one or more third-party systems. For example, the service matching system 100 can receive service information associated with third-party systems from the provider vehicle, the provider device 400, and/or the third-party systems.

In response to determining that the provider vehicle has not previously visited a vehicle service center (i.e., it is the first visit), the service matching system 100 can utilize a second preventative maintenance algorithm 456 to determine the preventative maintenance score 444. In one or more embodiments, as shown in FIG. 4K, the second preventative maintenance algorithm 456 locks the preventative maintenance score 444. For example, the service matching system 100 can determine a default score (e.g., based on the mileage for the vehicle) for first time visitors and lock the preventative maintenance score 444 at the default score. Alternatively, the service matching system 100 can determine a first time visitor score for all new provider vehicles visiting a vehicle service center for the first time.

In response to determining that the provider vehicle has previously visited a vehicle service center (i.e., it is not the first visit), the service matching system 100 can utilize a third preventative maintenance algorithm 458 to determine the preventative maintenance score 444. For instance, as FIG. 4K illustrates, the third preventative maintenance algorithm 458 can include the service matching system 100 determining a visit ratio value for the provider vehicle. In one or more embodiments, the visit ratio value can be based on the number of preventative maintenance visits that the provider vehicle has had after passing the threshold distance (e.g., after 30,000 miles) divided by a required (or suggested) number of preventative maintenance visits. As used herein, the term “preventative maintenance visit” refers to a visit by a provider vehicle to a vehicle service center for performing one or more maintenance tasks for the provider vehicle. To illustrate, the visit ratio value can be represented as

$$( \frac{Visits after threshold distance}{Required visits} ) 100.$$

To illustrate, if the provider vehicle has visited fulfilled four out of five required visits, the service matching system 100 can determine the visit ratio value as (4/5) 100=80 (out of 100). The service matching system 100 can then determine the preventative maintenance score by multiplying the resulting visit ratio value by 20% (or other weight assigned to preventative maintenance).

In addition to determining the preventative maintenance score 444, the service matching system 100 can determine the critical task score 446. For instance, the service matching system 100 can determine a score based on critical tasks completed for the provider vehicle. In one or more embodiments, the service matching system 100 uses a critical task ratio value represented as

$$( \frac{Critical tasks completed }{Critical tasks recommended} ) ( 100 ) .$$

As used herein, the terms “critical maintenance task” and “critical task” refer to maintenance tasks for a provider vehicle (e.g., that are outside of a regular maintenance schedule for a provider vehicle). For instance, a critical task can include tasks that are not included in a manufacturer's maintenance schedule. In particular, the service matching system 100 determines the number of tasks completed relative to the number of tasks recommended for the provider vehicle. To illustrate, the service matching system 100 can determine that two out of four recommended critical tasks have been completed for a provider vehicle, resulting in (2/4) 100=50. The service matching system 100 then applies a weight (e.g., 80%) to the ratio of completed tasks to recommended tasks to determine the critical task score 446.

Once the service matching system 100 has determined a preventative maintenance score 444 and a critical task score 446 for a provider vehicle, the service matching system 100 can determine the vehicle health score 448 for the provider vehicle. For example, in one or more embodiments, the service matching system 100 can add the preventative maintenance score 444 to the critical task score 446 based on the weighting applied to each score. Additionally, as previously mentioned, the service matching system 100 can present the vehicle health score 448 as a non-numerical value. For instance, the service matching system 100 can convert a numerical value of the vehicle health score 448 to a non-numerical value based on one or more thresholds/bounds. To illustrate, the service matching system 100 can determine that the vehicle health score 448 for a provider vehicle corresponds to a gold health score, a silver health score, or a bronze health score in response to comparing the vehicle health score 448 to numerical value ranges of 80-100, 60-80, and 0-60, respectively.

Although FIG. 4K illustrates a specific algorithm for determining a vehicle health score, the service matching system 100 can use one or more other algorithms and/or data to determine a vehicle health score. For example, in one or more embodiments, the vehicle health score can be dependent on a geographic region of the provider vehicle, resulting in different thresholds, visits, recommended tasks, and/or calculations. To illustrate, provider vehicles that operate in high traffic regions (e.g., Austin, Tex.) may experience more wear and tear than providers that operate in low traffic regions (e.g., Jackson, Wyo.). The service matching system 100 can thus adapt the vehicle health score to different circumstances of provider vehicles to more accurately determine a vehicle health.

Furthermore, the service matching system 100 can provide notifications based on a vehicle health score of a provider vehicle. For example, the service matching system 100 can detect when a vehicle health score drops below a threshold value (e.g., below 60) and then notify a provider device of one or more ways to raise the vehicle health score. To illustrate, the service matching system 100 can notify a provider device to complete one or more outstanding maintenance tasks (e.g., complete a preventative maintenance visit or complete a critical maintenance task). The service matching system 100 can also provide one or more incentives or penalties based on the vehicle health score. For instance, the service matching system 100 can provide discounts based on high vehicle health scores or limit transportation requests based on low vehicle health scores.

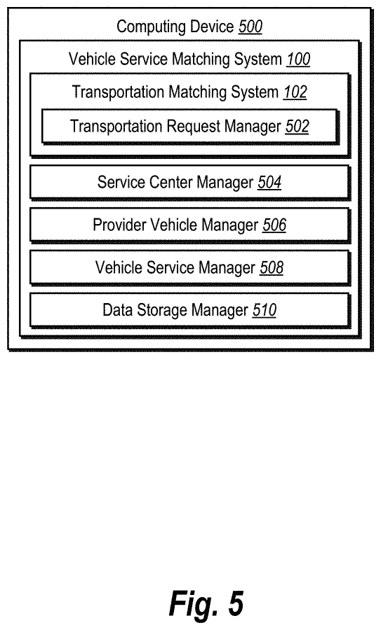

FIG. 5 illustrates a detailed schematic diagram of an example embodiment of the vehicle service matching system 100 described above. As shown, the service matching system 100 can be implemented on computing device(s) 500 (e.g., a server device and/or a client device), as further described below in relation to FIG. 7. Additionally, the service matching system 100 can include, but is not limited to, a transportation matching system 102—which includes a transportation request manager 502—a service center manager 504, a provider vehicle manager 506, a vehicle service manager 508, and a data storage manager 510. For example, the service matching system 100 can be implemented in a distributed system of server devices for managing servicing of vehicles associated with transportation providers. The service matching system 100 can also be implemented within one or more additional systems. Alternatively, the service matching system 100 can be implemented on a single computing device such as a single client device.

In one or more embodiments, each of the components of the service matching system 100 is in communication with other components using any suitable communication technologies. Additionally, the components of the service matching system 100 can be in communication with one or more other devices including other computing devices of a user, server devices (e.g., cloud storage devices), licensing servers, or other devices/systems. It will be recognized that although the components of the service matching system 100 are shown to be separate in FIG. 5, any of the subcomponents may be combined into fewer components, such as into a single component, or divided into more components as may serve a particular implementation. Furthermore, although the components of FIG. 5 are described in connection with the service matching system 100, at least some of the components for performing operations in conjunction with the service matching system 100 described herein may be implemented on other devices within the environment.

The components of the service matching system 100 can include software, hardware, or both. For example, the components of the service matching system 100 can include one or more instructions stored on a computer-readable storage medium and executable by processors of one or more computing devices (e.g., the computing device(s) 500). When executed by the one or more processors, the computer-executable instructions of the service matching system 100 can cause the computing device(s) 500 to perform the operations described herein. Alternatively, the components of the service matching system 100 can include hardware, such as a special purpose processing device to perform a certain function or group of functions. Additionally, or alternatively, the components of the service matching system 100 can include a combination of computer-executable instructions and hardware.

Furthermore, the components of the service matching system 100 performing the functions described herein with respect to the service matching system 100 may, for example, be implemented as part of a stand-alone application, as a module of an application, as a plug-in for applications, as a library function or functions that may be called by other applications, and/or as a cloud-computing model. Thus, the components of the service matching system 100 may be implemented as part of a stand-alone application on a personal computing device or a mobile device.

As described above, the service matching system 100 can include a transportation matching system 102 to facilitate providing transportation services to transportation requester. In particular, the transportation matching system 102 can include a transportation request manager 502 that facilitates management of transportation requests received from requester devices. The transportation request manager 502 can store information about the transportation requests including a pick-up location and a drop-off location for each request for the transportation matching system 102 to use in matching the requests.

The transportation matching system 102 can use information from the transportation request manager 502 to match requests to provider devices. For example, the transportation matching system 102 can match a transportation request to a provider device for a provider associated with the provider device to provide transportation to a requester of the transportation request. The transportation matching system 102 can also monitor fulfillment of transportation requests and assign new transportation requests based on provider availability. As described previously, the service matching system 100 can leverage the transportation matching system 102 to facilitate scheduling and performance of vehicle services for provider devices associated with the transportation matching system 102.

The service matching system 100 can also include a service center manager 504 to facilitate the management of one or more vehicle service centers. The service center manager 504 can communicate with computing devices associated with the vehicle service centers to obtain availability information associated with the vehicle service centers. For example, the service center manager 504 can obtain a schedule for each of the vehicle service centers (e.g., a waitlist). The service center manager 504 can also manage information about the vehicle service centers including, but not limited to, the number of technicians available, the number of stations in each of the maintenance, service, and collision tracks, and the types of services provided.

Additionally, the service matching system 100 can include a provider vehicle manager 506 to manage provider vehicles associated with the transportation matching system 102. For example, the provider vehicle manager 506 can store profile information for each provider vehicle including vehicle identification information, provider identification information, mileage, etc. The provider vehicle manager 506 can also store information about provider devices associated with each provider vehicle. Additionally, the provider vehicle manager 506 can store a service history for each provider vehicle indicating services that the provider vehicle has received from one or more vehicle service centers.

The service matching system 100 can also include a vehicle service manager 508 to facilitate matching provider vehicles to vehicle service centers for performing services on the provider vehicles. For instance, the vehicle service manager 508 can use information from the transportation matching system 102 to schedule service times for provider vehicles. The vehicle service manager 508 can also communicate with provider devices and technician devices during servicing of the provider vehicles to provide updates, requests, and/or relevant service information to providers/technicians within one or more user interfaces of provider/technician client applications.

The service matching system 100 can also include a data storage manager 510 (that comprises a non-transitory computer memory/one or more memory devices) to facilitate storage of data associated with matching provider vehicles to vehicle service centers and servicing the provider vehicles. The data storage manager 510 can communicate with any of the other components of the service matching system 100 to obtain and/or provide data. For example, the data storage manager 510 can store data related to vehicle service centers, provider vehicles, provider devices, provider profiles, and vehicle services.

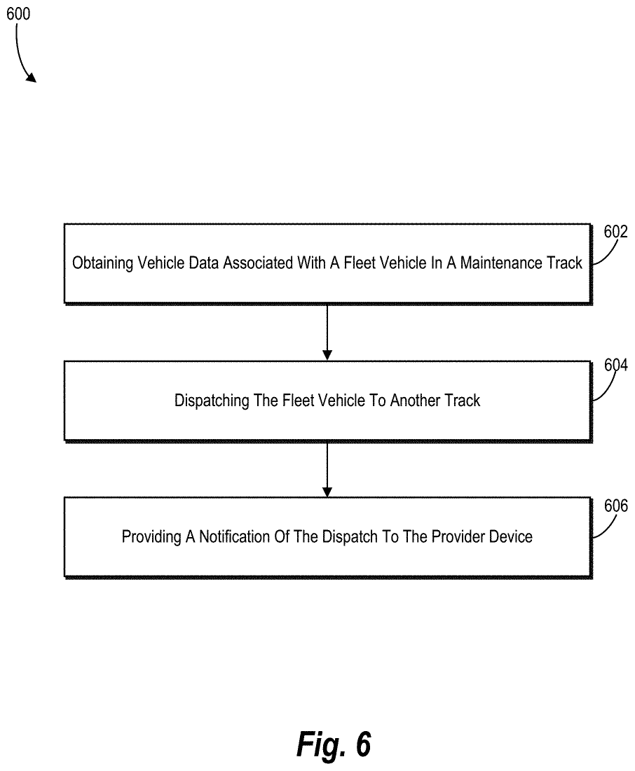

Turning now to FIG. 6, this figure shows a flowchart of a series of acts 600 of matching provider devices associated with a transportation matching system to service times at one or more vehicle service centers. While FIG. 6 illustrates acts according to one embodiment, alternative embodiments may omit, add to, reorder, and/or modify any of the acts shown in FIG. 6. The acts of FIG. 6 can be performed as part of a method. Alternatively, a non-transitory computer readable storage medium can comprise instructions that, when executed by one or more processors, cause a computing device to perform the acts depicted in FIG. 6. In still further embodiments, a system can perform the acts of FIG. 6.

As shown, the series of acts 600 includes an act 602 of obtaining vehicle data associated with a fleet vehicle in a maintenance track. For example, act 602 involves obtaining vehicle data associated with a fleet vehicle in a maintenance track of a vehicle service center. In one or more embodiments, the vehicle service center comprises the maintenance track, a service track, and a collision track. Additionally, in one or more embodiments, each of the maintenance track, the service track, and the collision track is a linear track comprising a single entry point and a single exit point for vehicles.

Furthermore, in one or more embodiments, the maintenance track comprises one or more cameras positioned to capture one or more images of vehicles in the maintenance track. Act 602 can thus involve identifying one or more images of the fleet vehicle from the one or more cameras. Act 602 can also involve utilizing one or more technician devices to perform maintenance services on the fleet vehicle and obtain vehicle data associated with the maintenance services.

The series of acts 600 also includes an act 604 of dispatching the fleet vehicle to another track. For example, act 604 involves, based on at least the vehicle data, dispatching the fleet vehicle to at least one of the maintenance track, the service track, or the collision track. Act 604 can also involve detecting, based on the one or more images of the fleet vehicle, a maintenance issue, a service issue, or a collision issue corresponding to the fleet vehicle. For instance, act 604 can involve utilizing a machine-learning model to detect the maintenance issue, the service issue, or the collision issue corresponding to the fleet vehicle from the one or more images of the fleet vehicle. Act 604 can then involve sending, to a provider device associated with the fleet vehicle, a request to dispatch the fleet vehicle to repair the maintenance issue, the service issue, or the collision issue detected from the one or more images of the fleet vehicle.

In one or more additional embodiments, act 604 can involve identifying a selected portion of the fleet vehicle in the captured one or more images in connection with the maintenance track. Act 604 can then involve providing the selected portion for display to a technician device corresponding to the one or more of the service track or the collision track.

Act 604 can also involve routing the fleet vehicle from a single exit point of the maintenance track to a single entry point of the service track or a single entry point of the collision track. For example, act 604 can involve routing the fleet vehicle through a linear progression of stations in the maintenance track to the single exit point of the maintenance track, and from the single exit point of the maintenance track to the single entry point of the service track or the single entry point of the collision track. Additionally, act 604, or an additional act, can involve routing the fleet vehicle through a linear progression of stations in the service track or the collision track.

Additionally, the series of acts 600 includes an act 606 of providing a notification of the dispatch to the fleet device. For example, act 606 involves providing, by the transportation matching system to a provider device associated with the fleet vehicle, a notification indicating that the fleet vehicle is being dispatched to the one or more of the service track or the collision track. Act 606 can involve providing the notification including a request to dispatch the fleet vehicle to the service track or the collision track. Act 606 can further involve dispatching the fleet vehicle to the one or more of the service track or the collision track in response to receiving, from the provider device, an approval of the request.

The series of acts 600 can also include providing, to the provider device associated with the fleet vehicle, an update notification indicating a location of the fleet vehicle within one or more of the maintenance track, the service track, or the collision track.

The series of acts 600 can also include utilizing a transportation matching system that matches transportation requests from requester devices to provider devices associated with fleet vehicles to perform the acts associated with obtaining the vehicle data, dispatching the fleet vehicle to another track, or providing a notification of the dispatch to the provider device. Furthermore, the series of acts 600 can include determining, prior to the fleet vehicle entering the maintenance track of the vehicle service center of the one or more vehicle service centers, that the fleet vehicle is due for maintenance at the one or more vehicle service centers. The series of acts 600 can also include determining a maintenance availability time at the vehicle service center of the one or more vehicle service centers. Furthermore, the series of acts 600 can include matching the provider device associated with the fleet vehicle to at least one transportation request based on a distance to the vehicle service center and the maintenance availability time.

In one or more embodiments, the series of acts 600 can also include determining a vehicle health score for the fleet vehicle based on the vehicle data, one or more preventative maintenance visits for the fleet vehicle, and one or more critical maintenance tasks for the fleet vehicle. Additionally, the series of acts 600 can include providing the vehicle health score for display to the provider device. Furthermore, the series of acts 600 can include providing, to the provider device, one or more recommended tasks based on the vehicle health score.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an exemplary computing device 700 that may be configured to perform one or more of the processes described above. One will appreciate that the service matching system 100 can comprise implementations of the computing device 700, including, but not limited to, the devices or systems illustrated in the previous figures. As shown by FIG. 7, the computing device can comprise a processor 702, memory 704, a storage device 706, an I/O interface 708, and a communication interface 710. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, storage device 706 can comprise a non-transitory storage medium described above. The storage device 706 may include a hard disk drive (“HDD”), flash memory, a Universal Serial Bus (“USB”) drive or a combination of these or other storage devices.

The computing device 700 also includes one or more input or output (“I/O”) interface 708, which are provided to allow a user (e.g., requester or provider) to provide input to (such as user strokes), receive output from, and otherwise transfer data to and from the computing device 700. These I/O interface 708 may include a mouse, keypad or a keyboard, a touch screen, camera, optical scanner, network interface, modem, other known I/O devices or a combination of such I/O interface 708. The touch screen may be activated with a stylus or a finger.

The I/O interface 708 may include one or more devices for presenting output to a user, including, but not limited to, a graphics engine, a display (e.g., a display screen), one or more output providers (e.g., display providers), one or more audio speakers, and one or more audio providers. In certain embodiments, interface 708 is configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 can provide one or more interfaces for communication (such as, for example, packet-based communication) between the computing device and one or more other computing devices 700 or one or more networks. As an example, and not by way of limitation, communication interface 710 may include a network interface controller (“NIC”) or network adapter for communicating with an Ethernet or other wire-based network or a wireless NIC (“WNIC”) or wireless adapter for communicating with a wireless network, such as a WI-FI. The computing device 700 can further include a bus 712. The bus 712 can comprise hardware, software, or both that couples components of computing device 700 to each other.

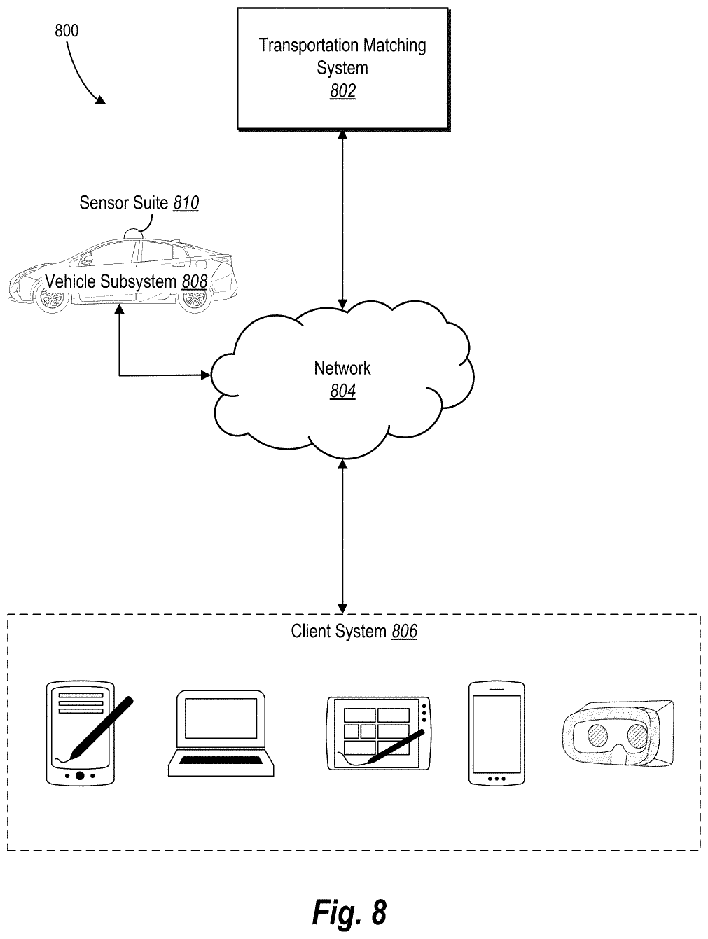

FIG. 8 illustrates an example network environment 800 of a transportation matching system 802. The network environment 800 includes a client device 806, a transportation matching system 802, and a vehicle subsystem 808 connected to each other by a network 804. Although FIG. 8 illustrates a particular arrangement of the client device 806, transportation matching system 802, vehicle subsystem 808, and network 804, this disclosure contemplates any suitable arrangement of client device 806, transportation matching system 802, vehicle subsystem 808, and network 804. As an example, and not by way of limitation, two or more of client device 806, transportation matching system 802, and vehicle subsystem 808 communicate directly, bypassing network 804. As another example, two or more of client device 806, transportation matching system 802, and vehicle subsystem 808 may be physically or logically co-located with each other in whole or in part. Moreover, although FIG. 8 illustrates a particular number of client devices 806, transportation matching systems 802, vehicle subsystems 808, and networks 804, this disclosure contemplates any suitable number of client devices 806, transportation matching systems 802, vehicle subsystems 808, and networks 804. As an example, and not by way of limitation, network environment 800 may include multiple client device 806, transportation matching systems 802, vehicle subsystems 808, and networks 804.

This disclosure contemplates any suitable network 804. As an example, and not by way of limitation, one or more portions of network 804 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 804 may include one or more networks 804.

Links may connect client device 806, transportation matching system 802, and vehicle subsystem 808 to network 804 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 800. One or more first links may differ in one or more respects from one or more second links.

In particular embodiments, client device 806 may be an electronic device including hardware, software, or embedded logic components or a combination of two or more such components and capable of carrying out the appropriate functionalities implemented or supported by client device 806. As an example, and not by way of limitation, a client device 806 may include any of the computing devices discussed above in relation to FIG. 7. A client device 806 may enable a network user at client device 806 to access network 804. A client device 806 may enable its user to communicate with other users at other client devices 806.

In particular embodiments, client device 806 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client device 806 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to client device 806 one or more Hyper Text Markup Language (“HTML”) files responsive to the HTTP request. Client device 806 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 802 may be a network-addressable computing system that can host a transportation matching network. Transportation matching system 802 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 802. In addition, the transportation matching system may manage identities of service requesters such as users/requesters. In particular, the transportation matching system 802 may maintain requester data such as driving/riding histories, personal data, or other user data in addition to navigation and/or traffic management services or other location services (e.g., GPS services).

In particular embodiments, the transportation matching system 802 may manage transportation matching services to connect a user/requester with a vehicle and/or provider. By managing the transportation matching services, the transportation matching system 802 can manage the distribution and allocation of resources from the vehicle subsystem 808 and user resources such as GPS location and availability indicators, as described herein.

Transportation matching system 802 may be accessed by the other components of network environment 800 either directly or via network 804. In particular embodiments, transportation matching system 802 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, transportation matching system 802 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 806, or a transportation matching system 802 to manage, retrieve, modify, add, or delete, the information stored in data store.

In particular embodiments, transportation matching system 802 may provide users with the ability to take actions on various types of items or objects, supported by transportation matching system 802. As an example, and not by way of limitation, the items and objects may include transportation matching networks to which users of transportation matching system 802 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in transportation matching system 802 or by an external system of a third-party system, which is separate from transportation matching system 802 and coupled to transportation matching system 802 via a network 804.

In particular embodiments, transportation matching system 802 may be capable of linking a variety of entities. As an example, and not by way of limitation, transportation matching system 802 may enable users to interact with each other or other entities, or to allow users to interact with these entities through an application programming interfaces (“API”) or other communication channels.

In particular embodiments, transportation matching system 802 may include a variety of servers, sub-systems, programs, modules, logs, and data stores. In particular embodiments, transportation matching system 802 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Transportation matching system 802 may also include suitable components such as network interfaces, security mechanisms, load balancers, failover servers, management-and-network-operations consoles, other suitable components, or any suitable combination thereof. In particular embodiments, transportation matching system 802 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between transportation matching system 802 and one or more client devices 806. An action logger may be used to receive communications from a web server about a user's actions on or off transportation matching system 802. In conjunction with the action log, a third-party-content-object log may be maintained of user exposures to third-party-content objects. A notification controller may provide information regarding content objects to a client device 806. Information may be pushed to a client device 806 as notifications, or information may be pulled from client device 806 responsive to a request received from client device 806. Authorization servers may be used to enforce one or more privacy settings of the users of transportation matching system 802. A privacy setting of a user determines how particular information associated with a user can be shared. The authorization server may allow users to opt in to or opt out of having their actions logged by transportation matching system 802 or shared with other systems, such as, for example, by setting appropriate privacy settings. Third-party-content-object stores may be used to store content objects received from third parties. Location stores may be used for storing location information received from client devices 806 associated with users.

In addition, the vehicle subsystem 808 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 808 can include an autonomous vehicle—i.e., a vehicle that does not require a human operator. In these embodiments, the vehicle subsystem 808 can perform maneuvers, communicate, and otherwise function without the aid of a human provider, in accordance with available technology.

In particular embodiments, the vehicle subsystem 808 may include one or more sensors incorporated therein or associated thereto. For example, sensor(s) 810 can be mounted on the top of the vehicle subsystem 808 or else can be located within the interior of the vehicle subsystem 808. In certain embodiments, the sensor(s) 810 can be located in multiple areas at once—i.e., split up throughout the vehicle subsystem 808 so that different components of the sensor(s) 810 can be placed in different locations in accordance with optimal operation of the sensor(s) 810. In these embodiments, the sensor(s) 810 can include a LIDAR sensor and an inertial measurement unit (“IMU”) including one or more accelerometers, one or more gyroscopes, and one or more magnetometers. The sensor(s) 810 can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 808 may include a communication device capable of communicating with the client device 806 and/or the transportation matching system 802. For example, the vehicle subsystem 808 can include an on-board computing device communicatively linked to the network 804 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

We claim:

1. A system comprising:
one or more vehicle service centers, each of the one or more vehicle service centers comprising a maintenance track, a service track, and a collision track;
at least one processor; and
a non-transitory computer readable storage medium comprising instructions that, when executed by the at least one processor, cause a computing device to:
obtain vehicle data associated with a fleet vehicle in the maintenance track of a vehicle service center of the one or more vehicle service centers;
based at least on the vehicle data, dispatch the fleet vehicle to at least one of the maintenance track, the service track, or the collision track of the vehicle service center; and
provide, to a provider device associated with the fleet vehicle, a notification indicating that the fleet vehicle is being dispatched to the at least one of the maintenance track, the service track, or the collision track of the vehicle service center.

2. The system of claim 1, wherein:
the maintenance track comprises one or more cameras positioned to capture one or more images of vehicles in the maintenance track; and
the non-transitory computer readable storage medium further comprises instructions that, when executed by the at least one processor, cause the computing device to identify one or more images of the fleet vehicle from the one or more cameras.

3. The system of claim 2, wherein the non-transitory computer readable storage medium further comprises instructions that, when executed by the at least one processor, cause the computing device to:
detect, based on the one or more images of the fleet vehicle, a maintenance issue, a service issue, or a collision issue corresponding to the fleet vehicle; and
send, to the provider device, a request to dispatch the fleet vehicle to repair the maintenance issue, the service issue, or the collision issue detected from the one or more images of the fleet vehicle.

4. The system of claim 2, wherein the non-transitory computer readable storage medium further comprises instructions that, when executed by the at least one processor, cause the computing device to:
identify a selected portion of the fleet vehicle in the captured one or more images in connection with the maintenance track; and
provide the selected portion for display to a technician device corresponding to the at least one of the maintenance track, the service track, or the collision track.

5. The system of claim 1, wherein the non-transitory computer readable storage medium further comprises instructions that, when executed by the at least one processor, cause the computing device to provide, to the provider device associated with the fleet vehicle, an update notification indicating a location of the fleet vehicle within the maintenance track, the service track, or the collision track.

6. The system of claim 1, wherein:
the maintenance track is a linear maintenance track comprising a single maintenance track entry point and a single maintenance track exit point, the service track is a linear service track comprising a single service track entry point and a single service track exit point, and the collision track is a linear collision track comprising a single collision track entry point and a single collision track exit point; and
the instructions that cause the computing device to dispatch the fleet vehicle from the maintenance track to the at least one of the maintenance track, the service track, or the collision track cause the computing device to route the fleet vehicle from the single maintenance track exit point to the single maintenance track entry point, the single service track entry point, or the single collision track entry point.

7. The system of claim 1, wherein the non-transitory computer readable storage medium further comprises instructions that, when executed by the at least one processor, cause the computing device to:
determine, prior to the fleet vehicle entering the maintenance track of the vehicle service center of the one or more vehicle service centers, that the fleet vehicle is due for maintenance at the one or more vehicle service centers;
determine a maintenance availability time at the vehicle service center of the one or more vehicle service centers; and
match the provider device associated with the fleet vehicle with at least one transportation request based on a distance to the vehicle service center and the maintenance availability time.

8. The system of claim 1, wherein the non-transitory computer readable storage medium further comprises instructions that, when executed by the at least one processor, cause the computing device to:
determine a vehicle health score for the fleet vehicle based on the vehicle data, one or more preventative maintenance visits for the fleet vehicle, and one or more critical maintenance tasks for the fleet vehicle; and
provide the vehicle health score for display to the provider device.

9. A computer-implemented method comprising:
obtaining vehicle data associated with a fleet vehicle in a maintenance track of a vehicle service center, wherein the vehicle service center comprises the maintenance track, a service track, and a collision track;
based on at least the vehicle data, dispatching the fleet vehicle to at least one of the maintenance track, the service track, or the collision track; and
providing, to a provider device associated with the fleet vehicle, a notification indicating that the fleet vehicle is being dispatched to the at least one of the maintenance track, the service track, or the collision track.

10. The computer-implemented method of claim 9, wherein obtaining the vehicle data associated with the fleet vehicle in the maintenance track of the vehicle service center comprises capturing one or more images of the fleet vehicle utilizing one or more cameras in the maintenance track.

11. The computer-implemented method of claim 10, wherein dispatching the fleet vehicle to the at least one of the maintenance track, the service track, or the collision track comprises:
detecting, based on the one or more images of the fleet vehicle, a maintenance issue, a service issue, or a collision issue corresponding to the fleet vehicle; and
sending, to the provider device, a request to dispatch the fleet vehicle to repair the maintenance issue, the service issue, or the collision issue detected from the one or more images of the fleet vehicle.

12. The computer-implemented method of claim 10, wherein dispatching the fleet vehicle to the at least one of the maintenance track, the service track, or the collision track comprises:
identifying a selected portion of the fleet vehicle in the captured one or more images in connection with the maintenance track; and
providing the selected portion for display to a technician device corresponding to the at least one of the maintenance track, the service track, or the collision track.

13. The computer-implemented method of claim 9, further comprising providing, to the provider device associated with the fleet vehicle, an update notification indicating a location of the fleet vehicle within the maintenance track, the service track, or the collision track.

14. The computer-implemented method of claim 9, wherein dispatching the fleet vehicle to the at least one of the maintenance track, the service track, or the collision track comprises routing the fleet vehicle from a single exit point of the maintenance track to a single entry point of the maintenance track, a single entry point of the service track, or a single entry point of the collision track.

15. The computer-implemented method of claim 9, further comprising:
determining, prior to the fleet vehicle entering the maintenance track of the vehicle service center of the one or more vehicle service centers, that the fleet vehicle is due for maintenance at the one or more vehicle service centers;
determining a maintenance availability time at the vehicle service center of the one or more vehicle service centers; and
matching the provider device associated with the fleet vehicle with at least one transportation request based on a distance to the vehicle service center and the maintenance availability time.

16. A non-transitory computer readable storage medium comprising instructions that, when executed by at least one processor, cause a computing device to:
obtain vehicle data associated with a fleet vehicle in a maintenance track of a vehicle service center, wherein the vehicle service center comprises the maintenance track, a service track, and a collision track;
based on at least the vehicle data, dispatch the fleet vehicle to at least one of the maintenance track, the service track, or the collision track; and
provide, to a provider device associated with the fleet vehicle, a notification indicating that the fleet vehicle is being dispatched to the at least one of the maintenance track, the service track, or the collision track.

17. The non-transitory computer readable storage medium of claim 16, wherein the instructions that cause the computing device to obtain the vehicle data associated with the fleet vehicle in the maintenance track of the vehicle service center further cause the computing device to capture one or more images of the fleet vehicle utilizing one or more cameras in the maintenance track.

18. The non-transitory computer readable storage medium of claim 17, wherein the instructions that cause the computing device to dispatch the fleet vehicle to the at least one of the maintenance track, the service track, or the collision track further cause the computing device to:
detect, based on the one or more images of the fleet vehicle, a maintenance issue, a service issue, or a collision issue corresponding to the fleet vehicle; and
send, to the provider device, a request to dispatch the fleet vehicle to repair the maintenance issue, the service issue, or the collision issue detected from the one or more images of the fleet vehicle.

19. The non-transitory computer readable storage medium of claim 17, wherein the instructions that cause the computing device to dispatch the fleet vehicle to the at least one of the maintenance track, the service track, or the collision track further cause the computing device to:
identify a selected portion of the fleet vehicle in the captured one or more images in connection with the maintenance track; and
provide the selected portion for display to a technician device corresponding to the at least one of the maintenance track, the service track, or the collision track.

20. The non-transitory computer readable storage medium of claim 16, further comprising instructions that, when executed by the at least one processor, cause the computing device to:
determine, prior to the fleet vehicle entering the maintenance track of the vehicle service center of the one or more vehicle service centers, that the fleet vehicle is due for maintenance at the one or more vehicle service centers;
determine a maintenance availability time at the vehicle service center of the one or more vehicle service centers; and
match the provider device associated with the fleet vehicle with at least one transportation request based on a distance to the vehicle service center and the maintenance availability time.
